(19) United States
(12) Patent Application Publication
(10) Pub. No.: US 2024/0303470 A1
(43) Pub. Date: Sep. 12, 2024

(54) CONSTRUCTION METHOD AND APPARATUS FOR BIPARTITE GRAPH, AND DISPLAY METHOD AND APPARATUS FOR BIPARTITE GRAPH

(71) Applicant: HUAWEI TECHNOLOGIES CO., LTD., Shenzhen (CN)

(72) Inventors: Zhongwei WANG, Hangzhou (CN); Rongchen ZHU, Hangzhou (CN); Han GAO, Hong Kong (CN)

(21) Appl. No.: 18/666,930

(22) Filed: May 17, 2024

Related U.S. Application Data
(63) Continuation of application No. PCT/CN2022/132189, filed on Nov. 16, 2022.

(30) Foreign Application Priority Data
Nov. 19, 2021 (CN) 202111381794.7

(51) Int. Cl. G06N 3/0464; G06N 3/0455; G06N 3/08; G06T 1/20

(52) U.S. Cl. CPC G06N 3/0464; G06N 3/0455; G06N 3/08; G06T 1/20

(57) ABSTRACT

This application discloses a construction method and apparatus for a bipartite graph, and a display method and apparatus for a bipartite graph. The construction method includes: searching a computational graph for at least one cross-communication edge corresponding to a first communication node, where the first communication node is one of M communication nodes included in the computational graph, the first communication node corresponds to P predecessor nodes and Q successor nodes, each of the at least one cross-communication edge indicates a communication path between one of the P predecessor nodes and one of the Q successor nodes, and no cross-communication edge passes through the M communication nodes; and cutting cross-communication edges respectively corresponding to the M communication nodes, and performing an aggregation operation to obtain the bipartite graph, where any two of the M communication nodes are connected without an edge in the bipartite graph.

### CROSS-REFERENCE TO RELATED APPLICATIONS

This application is a continuation of International Application No. PCT/CN2022/132189, filed on Nov. 16, 2022, which claims priority to Chinese Patent Application No. 202111381794.7, filed on Nov. 19, 2021. The disclosures of the aforementioned applications are hereby incorporated by reference in their entireties.

### TECHNICAL FIELD

This application relates to the field of artificial intelligence technologies, and in particular, to a construction method and apparatus for a bipartite graph, and a display method and apparatus for a bipartite graph.

### BACKGROUND

With continuous development of deep learning and continuous improvement of hardware computing power, a scale of a deep neural network becomes increasingly large. A large model usually uses a cluster for parallel training. Data or models are partitioned and distributed to different devices. In a computational graph that represents a parallel training process, a communication node indicates a data exchange task, and the data exchange task means data exchange between two or more devices (such as a Graphics Processing Unit (GPU)). Usually, researchers design an appropriate parallel policy to achieve a maximum computation-to-communication ratio, that is, to minimize time of pure communication. If parallel policy design is inappropriate, a redundant communication node may be introduced, causing a performance bottleneck at the communication node.

In a process of designing the parallel policy, researchers usually use the communication node as an entry to analyze and adjust the parallel policy of a model.

However, currently, when a tool such as TensorBoard is used to display the computational graph for parallel training, a structure of the large model cannot be clearly displayed, and the communication node can be seen only after layer-by-layer expansion. A process of locating the communication node is complex and cumbersome.

### SUMMARY

Embodiments of this application provide a construction method and apparatus for a bipartite graph, and a display method and apparatus for a bipartite graph, so that a communication node in a computational graph can be extracted to a top layer of the bipartite graph, to clearly display a model structure, and quickly and intuitively locate the communication node and specify a function of the communication node the communication node, so as to provide a basis for subsequent parallel policy design.

According to a first aspect, this application provides a construction method for a bipartite graph, including: searching a computational graph for at least one cross-communication edge corresponding to a first communication node, where the first communication node is one of M communication nodes included in the computational graph, the first communication node corresponds to P predecessor nodes and Q successor nodes, each of the at least one cross-communication edge indicates a communication path between one of the P predecessor nodes and one of the Q successor nodes, and no cross-communication edge passes through the M communication nodes, where M, P, and Q are positive integers; and cutting a cross-communication edge corresponding to each of the M communication nodes, and performing an aggregation operation to obtain the bipartite graph, where any two of the M communication nodes are directly connected without an edge in the bipartite graph.

A predecessor node corresponding to each communication node is a non-communication node through which a data flow passes before flowing into the communication node. A successor node corresponding to each communication node is a non-communication node through which a data flow passes after flowing out of the communication node. A cross-communication edge corresponding to each communication node includes a communication path between any one of the predecessor nodes corresponding to the communication node and any one of the successor nodes corresponding to the communication node, and no cross-communication edge passes through any communication node.

From the perspective of technical effects, in this application, the cross-communication edge corresponding to each communication node in the computational graph is cut, so that a path that only passes through the communication node is retained in the computational graph. In this manner, the communication node in the computational graph is extracted to a top layer of the bipartite graph, to clearly display a model structure, and quickly locate the communication node and specify a function of the communication node the communication node, so as to provide a basis for a fusion/grouping policy of the communication node in a subsequent model training process. This helps design an optimal parallel policy, and increase an overlap between computing time and communication time, that is, reduce training duration of a parallel training process.

In a feasible implementation, each cross-communication edge includes at least one subedge, and each of the at least one subedge is directly connected to two computation nodes. Each of the at least one subedge corresponds to one weight coefficient, and the weight coefficient corresponding to each subedge is determined by types of the two computation nodes directly connected to each subedge.

The computation node is also referred to as a computation operator, and is a node that cannot be expanded in the computational graph. A type of the computation operator is determined by a specific function of the computation operator. For example, for a log operator (Log Operator), a function of the log operator is to perform a logarithmic operation. Optionally, a type of the log operator may be Log. To be specific, a type of each computation operator is represented by an identifier of the computation operator.

From the perspective of technical effects, in this application, the corresponding weight coefficient is defined for the subedge in each cross-communication edge, and importance of each subedge is defined based on the weight coefficient, to provide a corresponding basis for subsequent cross-communication edge cutting.

In a feasible implementation, the sequentially cutting a cross-communication edge corresponding to each of the M communication nodes includes: if one subedge in an i^{th} cross-communication edge is already cut, skipping cutting the i^{th} cross-communication edge, where the i^{th} cross-communication edge is one cross-communication edge corresponding to any one of the M communication nodes; or, if none of subedges included in an i^{th} cross-communication edge is cut, cutting a subedge with a smallest weight coefficient or a largest weight coefficient among the subedges included in the i^{th} cross-communication edge, where the i^{th} cross-communication edge is one cross-communication edge corresponding to any one of the M communication nodes.

From the perspective of technical effects, when the cross-communication edge is cut, one subedge in the cross-communication edge is cut based on a weight coefficient of the subedge. In this way, the subedge with minimum importance can be cut. In addition, in the manner of cutting only one subedge, semantic information in the computational graph can be retained to a maximum extent.

In a feasible implementation, the computational graph after cutting includes K connected blocks, where K is a positive integer; and the performing an aggregation operation to obtain the bipartite graph includes: separately aggregating each connected block in the computational graph after the cutting to obtain the bipartite graph. The K connected blocks are obtained by grouping computation nodes in the computational graph based on positions of the M communication nodes in the computational graph, the bipartite graph includes K level-1 aggregation nodes and the M communication nodes, any two of the K level-1 aggregation nodes are directly connected without an edge, and the K level-1 aggregation nodes respectively belong to K name scopes.

The connected block (which may also be referred to as a connected component) means that: After a cross-communication edge is cut, a computational graph is separated by a barrier that includes communication nodes, and in this case, a subgraph that includes interconnected computation nodes in the computational graph is referred to as a connected block or a connected component. Each connected block includes at least one computation node.

From the perspective of technical effects, each connected block is separately aggregated, that is, the K connected blocks are separately aggregated to obtain the K level-1 aggregation nodes, to obtain the bipartite graph that includes the level-1 aggregation nodes and the communication nodes, so that a position and a function of the communication node can be quickly located based on the bipartite graph, to provide a corresponding basis for subsequent fusion/grouping of the communication node.

In a feasible implementation, each of the K level-1 aggregation nodes is of a hierarchical structure. Nodes at a j^{th} layer in the hierarchical structure are obtained by expanding a node at a (j−1)th layer in the hierarchical structure, a first layer in the hierarchical structure is the level-1 aggregation node, and the nodes at the j^{th} layer belong to different name scopes. The nodes at the j^{th} layer include the aggregation node and/or the computation node, and the computation node is a node that cannot be expanded.

Expanding above is an inverse process of aggregation. Aggregation means that a graph structure represented by at least one node and an edge between the at least one node is represented by using one node. Expanding means that a node is represented by using a graph structure that includes at least one node and an edge between the at least one node.

In a feasible implementation, the method further includes: updating a first name scope when a subedge between a first computation node and a second computation node in the first name scope is cut, where the first name scope is a name scope in the computational graph; and constructing a name scope that includes the first computation node, where the first computation node does not belong to an updated first name scope.

From the perspective of technical effects, after a subedge between two computation nodes is cut, there is a computation node that does not belong to an original name scope. In this case, a new name scope is established for the computation node, to meet a construction requirement of the bipartite graph.

In a feasible implementation, the method further includes: computing a hash value of the aggregation node and a hash value of the computation node in the bipartite graph. When the node is the aggregation node, a hash value of the node is equal to a sum of hash values of all nodes obtained by expanding the aggregation node; or when the node is the computation node, a hash value of the node is determined by at least one of the following: a type, an in-degree, an out-degree, a type of an auxiliary node, and a quantity of auxiliary nodes of the computation node.

Data that flows out of an auxiliary node of a computation node flows only into the computation node, and no data flows in to the auxiliary node of the computation node. The auxiliary node is usually a constant or a variable.

From the perspective of technical effects, a hash value of a node at each layer in the hierarchical structure of the aggregation node is computed, to provide a corresponding basis for displaying subsequent nodes in a stacked manner.

In a feasible implementation, the method further includes: displaying a plurality of nodes in the bipartite graph in a stacked manner. The plurality of nodes are obtained by expanding the same aggregation node once, hash values of the plurality of nodes are the same, and the plurality of nodes are connected in serial or parallel.

Optionally, displaying in a stacked manner means that, in the bipartite graph, a stack structure that includes a connection relationship identifier and a quantity identifier is used to display the plurality of nodes that meet the foregoing condition. The connection relationship identifier represents a connection relationship between the plurality of nodes, for example, a parallel connection or a serial connection. The quantity identifier indicates a quantity of the plurality of nodes that meet the foregoing condition. The foregoing condition means the plurality of nodes that are obtained by expanding the same aggregation node once, that have a same hash value, and whose connection relationship is a serial connection or a parallel connection.

From the perspective of technical effects, in the hierarchical structure, it may be considered that nodes with a same hash value have a same internal structure. Therefore, when the nodes are connected in serial or parallel, the nodes may be displayed in a stacked manner at a corresponding layer, so that an internal structure of the aggregation node is clearly and concisely displayed.

According to a second aspect, this application provides a display method for a bipartite graph. The method includes: inputting a computational graph, and outputting the bipartite graph based on the computational graph. The computational graph includes M communication nodes, a first communication node in the M communication nodes corresponds to P predecessor nodes and Q successor nodes, the first communication node corresponds to at least one cross-communication edge, each of the at least one cross-communication edge indicates a communication path between one of the P predecessor nodes and one of the Q successor nodes, and no cross-communication edge passes through the M communication nodes, where P, Q, and M are positive integers. Cross-communication edges respectively corresponding to the M communication nodes are not connected in the bipartite graph, and any two of the M communication nodes are directly connected without an edge in the bipartite graph.

From the perspective of technical effects, in this application, the cross-communication edge corresponding to each communication node in the computational graph is removed, so that only a path on which a data flow passes through the communication node is retained in the computational graph. In this manner, the communication node in the computational graph is extracted to a top layer of the bipartite graph, to clearly display a model structure, and quickly locate the communication node and specify a function of the communication node the communication node, so as to provide a basis for a fusion/grouping policy of the communication node in a subsequent model training process. This helps design an optimal parallel policy, and increase an overlap between computing time and communication time, that is, reduce training duration of a parallel training process.

In a feasible implementation, the computational graph includes C computation nodes, and the bipartite graph includes K level-1 aggregation nodes. The K level-1 aggregation nodes are obtained by aggregating the C computation nodes, each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, where C, K, and j are positive integers. The nodes at the j^{th} layer include the aggregation node and/or the computation node, and the computation node is a node that cannot be expanded.

In a feasible implementation, the bipartite graph includes a stack structure. The stack structure includes a connection relationship identifier and a quantity identifier. The connection relationship identifier represents a connection relationship between a plurality of nodes. The quantity identifier represents a quantity of the plurality of nodes. The plurality of nodes are obtained by expanding the same aggregation node once, hash values of the plurality of nodes are the same, and the connection relationship between the plurality of nodes is a serial connection or a parallel connection.

In a feasible implementation, when the node is the aggregation node, a hash value of the node is equal to a sum of hash values of all nodes obtained by expanding the aggregation node; or when the node is the computation node, a hash value of the node is determined by an attribute of the computation node, where the attribute of the computation node includes a type, an in-degree, an out-degree, a type of an auxiliary node, and a quantity of auxiliary nodes of the computation node.

Specifically, a specific process of obtaining the bipartite graph based on the computational graph in the second aspect is the same as the corresponding process in the first aspect. Details are not described herein again.

According to a third aspect, this application provides a construction apparatus for a bipartite graph, including: a searching unit, configured to search a computational graph for at least one cross-communication edge corresponding to a first communication node, where the first communication node is one of M communication nodes included in the computational graph, the first communication node corresponds to P predecessor nodes and Q successor nodes, each of the at least one cross-communication edge indicates a communication path between one of the P predecessor nodes and one of the Q successor nodes, and no cross-communication edge passes through the M communication nodes, where M, P, and Q are positive integers; and a cutting unit, configured to cut cross-communication edges respectively corresponding to the M communication nodes, and perform an aggregation operation to obtain the bipartite graph, where any two of the M communication nodes are directly connected without an edge in the bipartite graph.

In a feasible implementation, each cross-communication edge includes at least one subedge, and each of the at least one subedge is directly connected to two computation nodes. Each of the at least one subedge corresponds to one weight coefficient, and the weight coefficient corresponding to each subedge is determined by types of the two computation nodes directly connected to each subedge.

In a feasible implementation, the M communication nodes correspond to a total of N cross-communication edges, where N is a positive integer; and in the aspect of cutting cross-communication edges respectively corresponding to the M communication nodes, the cutting unit is specifically configured to: cut one subedge in each of the N cross-communication edges. When E cross-communication edges in the N cross-communication edges include a common subedge, a sum of weight coefficients respectively corresponding to all subedges cut in the E cross-communication edges is the largest or the smallest, where E is a positive integer less than or equal to N; or when an i^{th} cross-communication edge and another cross-communication edge in the N cross-communication edges do not include a common subedge, a subedge with a smallest weight coefficient or a largest weight coefficient among subedges included in the i^{th} cross-communication edge is cut, where i is a positive integer.

In a feasible implementation, the computational graph after cutting includes K connected blocks, where K is a positive integer; and in the aspect of performing an aggregation operation to obtain the bipartite graph, the cutting unit is specifically configured to: separately aggregate the K connected blocks in the computational graph after the cutting to obtain the bipartite graph. The K connected blocks are obtained by grouping computation nodes in the computational graph based on positions of the M communication nodes in the computational graph, the bipartite graph includes K level-1 aggregation nodes and the M communication nodes, any two of the K level-1 aggregation nodes are directly connected without an edge, and the K level-1 aggregation nodes respectively belong to K name scopes.

In a feasible implementation, each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, where j is a positive integer. The nodes at the j^{th} layer include the aggregation node and/or the computation node, and the computation node is a node that cannot be expanded.

In a feasible implementation, the apparatus further includes: an update unit, configured to update a first name scope when a subedge between a first computation node and a second computation node in the first name scope is cut, where the first name scope is a name scope in the computational graph; and a reconstruction unit, configured to construct a name scope that includes the first computation node, where the first computation node does not belong to an updated first name scope.

In a feasible implementation, the apparatus further includes: a computation unit, configured to compute a hash value of the aggregation node and a hash value of the computation node in the bipartite graph. When the node is the aggregation node, a hash value of the node is equal to a sum of hash values of all nodes obtained by expanding the aggregation node; or when the node is the computation node, a hash value of the node is determined by an attribute of the computation node, where the attribute of the computation node includes a type, an in-degree, an out-degree, a type of an auxiliary node, and a quantity of auxiliary nodes of the computation node.

In a feasible implementation, the apparatus further includes: a stacking unit, configured to display a plurality of nodes in the bipartite graph in a stacked manner. The plurality of nodes are obtained by expanding the same aggregation node once, hash values of the plurality of nodes are the same, and the plurality of nodes are connected in serial or parallel.

According to a fourth aspect, this application provides a display apparatus for a bipartite graph. The apparatus includes: an input unit, configured to input a computational graph; and a display unit, configured to display the bipartite graph based on the computational graph. The computational graph includes M communication nodes, a first communication node in the M communication nodes corresponds to P predecessor nodes and Q successor nodes, the first communication node corresponds to at least one cross-communication edge, each of the at least one cross-communication edge indicates a communication path between one of the P predecessor nodes and one of the Q successor nodes, and no cross-communication edge passes through the M communication nodes, where P, Q, and M are positive integers. Cross-communication edges respectively corresponding to the M communication nodes are not connected in the bipartite graph, and any two of the M communication nodes are directly connected without an edge in the bipartite graph.

In a feasible implementation, the computational graph includes C computation nodes, and the bipartite graph includes K level-1 aggregation nodes. The K level-1 aggregation nodes are obtained by aggregating the C computation nodes, each of the K level-1 aggregation nodes is of a hierarchical structure, nodes at a j^{th} layer in the hierarchical structure are obtained by expanding an aggregation node at a (j−1)th layer in the hierarchical structure, a first layer in the hierarchical structure is the level-1 aggregation node, and the nodes at the j^{th} layer belong to different name scopes, where C, K, and j are positive integers. The nodes at the j^{th} layer include the aggregation node and/or the computation node, and the computation node is a node that cannot be expanded.

In a feasible implementation, the bipartite graph includes a stack structure. The stack structure includes a connection relationship identifier and a quantity identifier. The connection relationship identifier represents a connection relationship between a plurality of nodes. The quantity identifier represents a quantity of the plurality of nodes. The plurality of nodes are obtained by expanding the same aggregation node once, hash values of the plurality of nodes are the same, and the connection relationship between the plurality of nodes is a serial connection or a parallel connection.

In a feasible implementation, when the node is the aggregation node, a hash value of the node is equal to a sum of hash values of all nodes obtained by expanding the aggregation node; or when the node is the computation node, a hash value of the node is determined by an attribute of the computation node, where the attribute of the computation node includes a type, an in-degree, an out-degree, a type of an auxiliary node, and a quantity of auxiliary nodes of the computation node.

Specifically, a specific process of obtaining the bipartite graph based on the computational graph in the display apparatus for the bipartite graph in the fourth aspect is the same as the corresponding process of constructing the bipartite graph in the display method for the bipartite graph in the second aspect. Details are not described herein again.

According to a fifth aspect, this application provides a computer-readable storage medium. The computer-readable storage medium stores a computer program. When the computer program is executed, the method according to any one of the first aspect is implemented.

According to a sixth aspect, this application provides a computer program. The computer program includes instructions. When the computer program is executed, the method according to any one of the first aspect is implemented.

### BRIEF DESCRIPTION OF DRAWINGS

The following describes the accompanying drawings used in embodiments of this application.

FIG. 1 is a schematic diagram of a system architecture according to an embodiment of this application;

FIG. 2 is a schematic diagram of an application scenario according to an embodiment of this application;

FIG. 3 is a schematic flowchart of a construction method for a bipartite graph according to an embodiment of this application;

FIG. 4 is a schematic diagram of a structure of a computational graph according to an embodiment of this application;

FIG. 5(a) and FIG. 5(b) are schematic diagrams of a cross-communication edge cutting manner according to an embodiment of this application;

FIG. 6(a) to FIG. 6(c) are schematic diagrams of another cross-communication edge cutting manner according to an embodiment of this application;

FIG. 7 is a schematic diagram of a structure of a bipartite graph according to an embodiment of this application;

FIG. 8 is a schematic diagram of a hierarchical structure of name scopes according to an embodiment of this application;

FIG. 9 is a schematic diagram of a process of aggregating computation nodes based on a hierarchical structure of name scopes according to an embodiment of this application;

FIG. 10(a) to FIG. 10(d) are example diagrams of a process of aggregating connected blocks according to an embodiment of this application;

FIG. 11 is a schematic diagram of a structure of a serial connection and a parallel connection of nodes according to an embodiment of this application;

FIG. 12(a) and FIG. 12(b) are schematic diagrams of a process of expanding stacked aggregation nodes according to an embodiment of this application;

FIG. 13(a) and FIG. 13(b) show examples of timelines of a model training process according to an embodiment of this application;

FIG. 14 is a schematic flowchart of a display method for a bipartite graph according to an embodiment of this application;

FIG. 15 is a schematic diagram of a structure of a construction apparatus for a bipartite graph according to an embodiment of this application;

FIG. 16 is a schematic diagram of a structure of a display apparatus for a bipartite graph according to an embodiment of this application;

FIG. 17 is a schematic diagram of a hardware structure of a construction apparatus for a bipartite graph according to an embodiment of this application; and

FIG. 18 is a schematic diagram of a hardware structure of a display apparatus for a bipartite graph according to an embodiment of this application.

### DESCRIPTION OF EMBODIMENTS

The following describes embodiments of this application with reference to the accompanying drawings in embodiments of this application. The terms such as “first”, “second”, “third”, and “fourth” in the specification, claims, and the accompanying drawings of this application are intended to distinguish between different objects, but are not intended to describe a specific order. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device. An “embodiment” mentioned in this specification means that a particular feature, structure, or characteristic described with reference to embodiments may be included in at least one embodiment of this application. The phrase shown in various locations in this specification may not necessarily refer to a same embodiment, and is not an independent or optional embodiment exclusive from another embodiment. It is explicitly and implicitly understood by a person skilled in the art that embodiments described in this specification may be combined with another embodiment.

First, related terms in embodiments of this application are explained.
(1) Parallel training: A plurality of graphics processing units (Graphics Processing Units, GPUs) participate in a training process of a neural network model. A parallel training manner includes data parallelism, model parallelism, pipeline parallelism, and the like.
(2) Computational graph visualization: is a process of visually displaying a computing process and a data flow of a deep learning model in a computational graph.
(3) Bipartite graph: If all nodes in a graph may be divided into two disjoint subsets, two nodes connected to each edge in the graph belong to the two disjoint subsets, and any two nodes in each of the two subsets are directly connected without an edge, the graph is a bipartite graph.
(4) Node (Node): Nodes in the computational graph include a node that can be expanded and a node that cannot be expanded. The node that can be expanded is referred to as an aggregation node, and the node that can be expanded means that the node may be represented by using a graph structure that includes at least one node and an edge between the at least one node. The node that cannot be expanded in the computational graph may be classified into two types: a computation node and a communication node, or may be referred to as a computation operator and a communication operator. In a computational graph that represents a parallel training process, a communication operator indicates a data exchange task, and the data exchange task means data exchange between two or more devices (such as a GPU device). The computation operator is another operator other than the communication node in the computational graph, for example, a gather operator (AllGather Operator), a broadcast operator (Broadcast Operator), a convolution operator (Conv2D Operator), a maximum pooling operator (MaxPool Operator), an add operator (Add Operator), a log operator (Log Operator), a sort operator (Sort Operator), and a transpose operator (Transpose Operator).
(5) Aggregation node: indicates a node that can be expanded in a bipartite graph. The aggregation node is obtained based on a name scope, and stores node information in the aggregation node, including a subnode list of the aggregation node, and attributes such as whether the node is expanded, which provide support for a subsequent interactive exploration module.
(6) Predecessor node: A predecessor node corresponding to each communication node is a non-communication node through which a data flow passes before flowing into the communication node.
(7) Successor node: A successor node corresponding to each communication node is a non-communication node through which a data flow passes after flowing out of the communication node.
(8) Data flow: An arrow on each edge in the computational graph indicates a data flow direction between two nodes that are directly connected to the edge, that is, flowing out from one node and flowing into another node.
(9) Cross-communication edge: A cross-communication edge corresponding to each communication node includes a communication path between any one of predecessor nodes corresponding to the communication node and any one of successor nodes corresponding to the communication node, and no cross-communication edge passes through any intermediate communication node.
(10) Connected block/Connected component: After a cross-communication edge is cut, the computational graph is separated by a barrier that includes communication nodes. In this case, a subgraph that includes interconnected computation nodes in the computational graph is referred to as a connected block or a connected component. Each connected block includes at least one computation node.
(11) Name scope (Name Scope): When generating a neural network computational graph, a deep learning framework groups nodes based on computational logic, generates a name scope for each node, parses the name scope in computational graph data, and obtains a data flow diagram with hierarchical information.
(12) Deep learning (Deep Learning) framework: indicates a structure in which a plurality of layers of learning are performed at different abstraction layers by using machine learning algorithms. Deep learning frameworks include PaddlePaddle, TensorFlow, Caffe, Theano, MXNet, Torch, and PyTorch.

The following describes a system architecture and an application scenario in embodiments of this application.

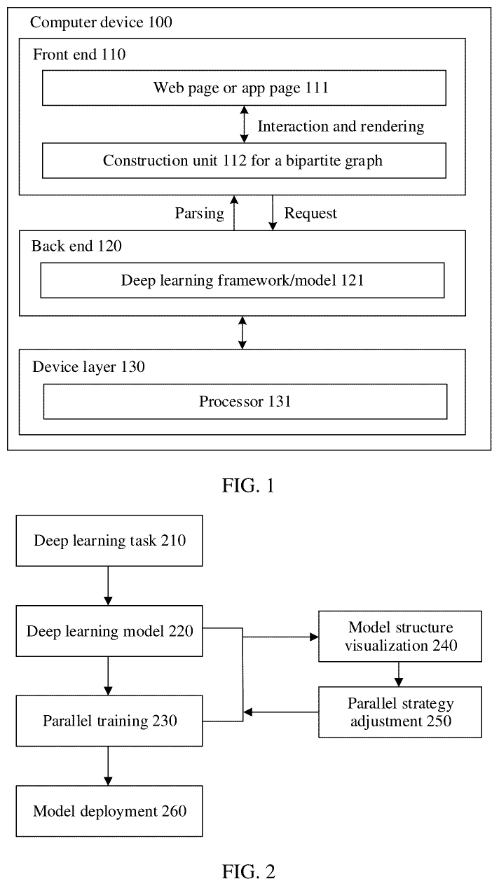

FIG. 1 is a schematic diagram of a system architecture according to an embodiment of this application. This diagram is used to describe a system architecture of a computer device 100. As shown in FIG. 1, the system architecture of the computer device 100 may include a front end 110, a back end 120, and a device layer 130.

Optionally, the computer device 100 may be a mobile phone, a computer, a tablet computer, a server, or the like. This is not limited in this application.

Optionally, the front end 110 may include a web (Web) page or application (App) page 111, and a construction unit 112 for a bipartite graph. The construction unit 112 for the bipartite graph may send a request to the back end 120, for example, read computational graph data in a specific format (for example, a JSON format) from a server or a host directory, parse the read computational graph data, and construct a corresponding bipartite graph (this process is also a main process in this application, and is described in specific embodiments below). After the bipartite graph is constructed, a user can continuously perform interaction and rendering on the web page or app page, to adjust and display a form of the bipartite graph and analyze a corresponding model structure and function.

Optionally, the back end 120 stores a deep learning framework/model 121, configured to execute various deep learning tasks, such as tasks that require model parallel training in image processing, natural language processing, or another field (such as scientific computing or physical modeling). This is not limited in this application. In addition, the back end 120 may convert the stored deep learning model into computational graph data in a specific format for the front end 110 to read. In an actual processing process, for a computational graph of an input deep learning model, only a unified storage and parsing format needs to be configured for computational graph data, so that the computational graph can be visualized by using the solutions in this application, to obtain a bipartite graph corresponding to the deep learning model.

Optionally, the device layer 130 includes a processor 131. The processor 131 may be a plurality of graphics processing units GPUs and/or central processing units (Central Processing Units, CPUs), and is configured to perform parallel training on the deep learning framework/model 121 and perform execution after the training ends.

FIG. 2 is a schematic diagram of an application scenario according to an embodiment of this application. It should be understood that the construction method for the bipartite graph in embodiments of this application may be applied to a scenario in which a deep learning model needs to be used for data processing and parallel training needs to be performed on the deep learning model in fields such as artificial intelligence (for example, image processing or natural language processing) and scientific computing.

First, a user constructs a corresponding deep learning model 220 based on a specific deep learning task 210. The deep learning task 210 may be an image processing task such as image recognition, object detection, or image segmentation, or may be a natural language processing task such as speech and semantic recognition. This is not limited in this application. The deep learning model 220 may be a convolutional neural network (Convolutional Neural Network, CNN) model, a deep belief network (Deep Belief Network, DBN) model, a stacked auto-encoder network (Stacked Auto-encoder Network) model, or the like. Then, parallel training 230 is performed on the deep learning model. To be specific, a training process of the model may be split into different GPUs or CPUs for parallel execution.

Further, based on computational graph data generated in the training process of the deep learning model 220, model structure visualization 240 is performed by using the method in embodiments of this application. To be specific, a bipartite graph corresponding to the computational graph data is constructed and displayed on a graphical user interface (Graphical User Interface, GUI). The user quickly locates a position and a corresponding function of a communication node based on the visualized bipartite graph, to perform parallel policy adjustment 250 based thereon. For example, a fusion/grouping policy of the communication node may be quickly determined, so that a communication ratio is minimized in a parallel training process. That is, communication duration in the training process is reduced to a minimum extent.

After the trained deep learning model is obtained, model deployment 260 is performed. To be specific, the model is deployed on various feasible computer devices such as a mobile phone, a computer, and a server. This is not limited in this application.

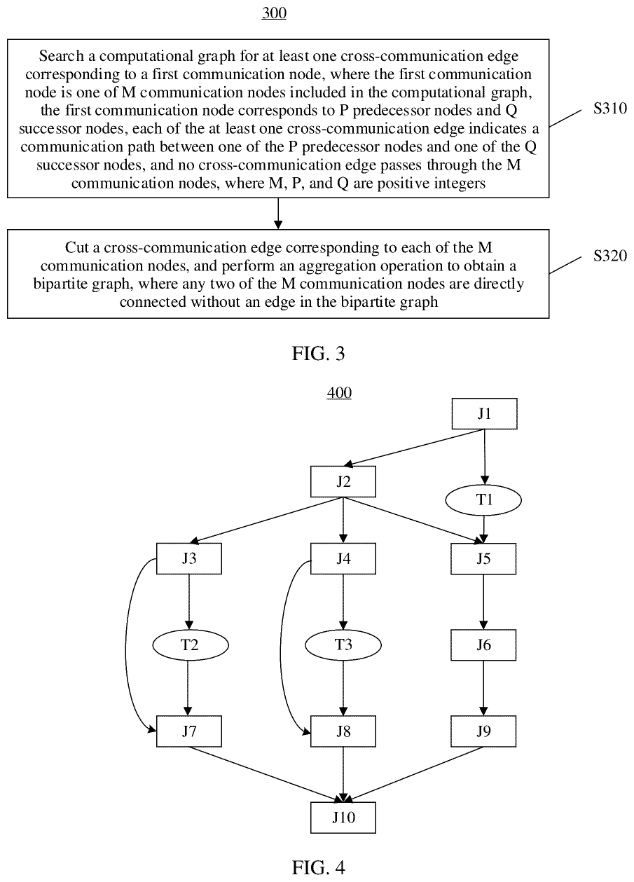

FIG. 3 is a schematic flowchart of a construction method for a bipartite graph according to an embodiment of this application. As shown in FIG. 3, the method 300 includes step S310 and step S320.

Step S310: Search a computational graph for at least one cross-communication edge corresponding to a first communication node, where the first communication node is one of M communication nodes included in the computational graph, the first communication node corresponds to P predecessor nodes and Q successor nodes, each of the at least one cross-communication edge indicates a communication path between one of the P predecessor nodes and one of the Q successor nodes, and no cross-communication edge passes through the M communication nodes, where M, P, and Q are positive integers.

The computational graph may be an expanded computational graph. To be specific, a node in the computational graph is a computation node or a communication node, and cannot be expanded. The computational graph may be a directed graph. To be specific, an edge (or referred to as a data flow) between any two directly connected nodes in the computational graph is directional, and indicates a data flow direction between the two nodes.

Optionally, predecessor nodes corresponding to each communication node may be all non-communication nodes through which a data flow passes before flowing into the communication node.

Optionally, successor nodes corresponding to each communication node may be all non-communication nodes through which a data flow passes after flowing out of the communication node.

Specifically, the predecessor nodes corresponding to the first communication node are all computation nodes before a logical sequence of the first communication node in the computational graph (that is, the nodes through which the data flow passes before flowing into the first communication node), and do not include the first communication node. There are a total of P predecessor nodes. The successor nodes corresponding to the first communication node are all computation nodes after a logical sequence of the first communication node in the computational graph (that is, the nodes through which the data flow passes after flowing out of the first communication node), and do not include the first communication node. There are a total of Q successor nodes.

Optionally, the searching a computational graph for at least one cross-communication edge corresponding to a first communication node is specifically: searching for a communication path that is between each of the P predecessor nodes and a 1^{st}, 2^{nd}, 3^{rd} . . . , or Q^{th} successor node and that does not pass through any communication node. Each found communication path is one cross-communication edge, and a total of N cross-communication edges are found, where N is a positive integer. It should be noted that a quantity of cross-communication edges between any one of the P predecessor nodes and any one of the Q successor nodes is an integer greater than or equal to 0.

It should be understood that a process of searching for a cross-communication edge corresponding to any communication node in a computational graph is the same as the process of searching for the cross-communication edge corresponding to the first communication node. Details are not described herein again.

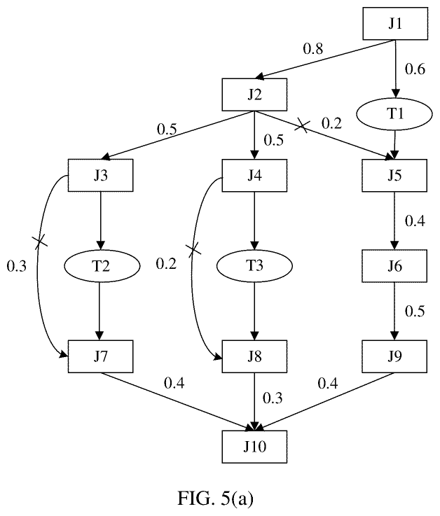

The following uses a computational graph shown in FIG. 4 as an example to describe the process of searching for a cross-communication edge corresponding to a communication node.

FIG. 4 is a schematic diagram of a structure of a computational graph according to an embodiment of this application. As shown in FIG. 4, the computational graph 400 includes communication nodes and computation nodes. The communication nodes are represented by T, including T1, T2, and T3. The computation nodes are represented by J, including J1, J2, . . . , and J10.

The communication node T1 corresponds to one predecessor node J1, and corresponds to four successor nodes: J5, J6, J9, and J10. Therefore, there are a total of six cross-communication edges corresponding to the communication node T1, which are J1-J2-J5, J1-J2-J5-J6, J1-J2-J5-J6-J9, J1-J2-J5-J6-J9-J10, J1-J2-J4-J8-J10, and J1-J2-J3-J7-J10, respectively.

The communication node T2 corresponds to three predecessor nodes: J1, J2, and J3, and corresponds to two successor nodes: J7 and J10. Therefore, there are a total of 10 cross-communication edges corresponding to the communication node T2, which are J3-J7, J3-J7-J10, J2-J3-J7, J2-J3-J7-J10, J2-J4-J8-J10, J2-J5-J6-J9-J10, J1-J2-J3-J7, J1-J2-J5-J6-J9-J10, J1-J2-J4-J8-J10, and J1-J2-J3-J7-J10, respectively.

The communication node T3 corresponds to three predecessor nodes: J1, J2, and J4, and corresponds to two successor nodes: J8 and J10. Therefore, there are a total of 10 cross-communication edges corresponding to the communication node T3, which are J4-J8, J4-J8-J10, J2-J4-J8, J2-J4-J8-J10, J2-J5-J6-J9-J10, J2-J3-J7-J10, J1-J2-J4-J8, J1-J2-J5-J6-J9-J10, J1-J2-J4-J8-J10, and J1-J2-J3-J7-J10, respectively.

It can be learned that the foregoing different communication nodes may correspond to same cross-communication edges.

In conclusion, after the same cross-communication edges corresponding to the different nodes are removed, the three communication nodes in the computational graph 400 correspond to a total of 17 cross-communication edges.

In a feasible implementation, each cross-communication edge includes at least one subedge, and each of the at least one subedge is directly connected to two computation nodes. Each of the at least one subedge corresponds to one weight coefficient, and the weight coefficient corresponding to each subedge is determined by types of the two computation nodes directly connected to each subedge.

In the computational graph, a subedge is an edge between two directly connected computation nodes, and each cross-communication edge includes at least one subedge.

A type of a computation operator is determined by a specific function of the computation operator. For example, for a log operator (Log Operator), a function of the log operator is to perform a logarithmic operation. Optionally, a type of the log operator may be Log. To be specific, a type of each computation operator is represented by an identifier of the computation operator.

Optionally, a user may determine, based on types of two computation nodes directly connected to each subedge, a weight coefficient of the subedge that is connected the two computation nodes. This is not limited in this application.

For example, for a computational graph constructed by using a MindSpore framework, the computational graph includes a Reshape node, a Tile node, and a Mul node that are directly connected sequentially. The Reshape node and the Tile node are nodes for performing a tensor operation and have similar logic, and the Mul node is a node for performing a mathematical operation. Therefore, when subedge cutting is performed, the user prefers to retain subedges connected between the Reshape node and the Tile node. In this case, a larger weight coefficient may be assigned to the subedge between the Reshape node and the Tile node, and a smaller weight coefficient may be assigned to a subedge between the Tile node and the Mul node.

Optionally, the weight coefficient may represent importance of a corresponding subedge. For example, a larger weight coefficient indicates higher importance of the subedge; or a smaller weight coefficient indicates lower importance of the subedge.

Optionally, values of weight coefficients corresponding to all subedges may range from 0 to 1. It should be understood that the value range of the weight coefficient corresponding to the subedge may be another value range. This is not limited in this application.

It should be understood that, a manner of determining the weight coefficient of the subedge included in the cross-communication edge corresponding to each communication node in the computational graph is the same as a manner of determining a weight coefficient of the subedge included in the cross-communication edge corresponding to the first communication node. Details are not described herein again.

Step S320: Cut cross-communication edges respectively corresponding to the M communication nodes, and perform an aggregation operation to obtain the bipartite graph, where any two of the M communication nodes are directly connected without an edge in the bipartite graph.

Specifically, the cross-communication edges corresponding to the M communication nodes in the computational graph are cut, to obtain the computational graph after cutting. The computational graph after the cutting includes K connected blocks and the M communication nodes, where K is a positive integer. The aggregation operation is performed on the computational graph after the cutting to obtain the bipartite graph. All nodes in the bipartite graph may be divided into two sets, any two nodes in either of the two sets are directly connected without an edge, and one of the two sets is a set that includes the M communication nodes.

In a feasible implementation, the M communication nodes correspond to a total of N cross-communication edges, where N is a positive integer; and the cutting cross-communication edges respectively corresponding to the M communication nodes includes: cutting one subedge in each of the N cross-communication edges. When E cross-communication edges in the N cross-communication edges include a common subedge, a sum of weight coefficients respectively corresponding to all subedges cut in the E cross-communication edges is the largest or the smallest, where E is a positive integer less than or equal to N; or when an i^{th} cross-communication edge and another cross-communication edge in the N cross-communication edges do not include a common subedge, a subedge with a smallest weight coefficient or a largest weight coefficient among subedges included in the i^{th} cross-communication edge is cut, where i is a positive integer.

It should be understood that different communication nodes may correspond to a same cross-communication edge, and the total of N cross-communication edges corresponding to the M communication nodes do not include a same cross-communication edge.

Specifically, when the cross-communication edges corresponding to the M communication nodes are cut, only one subedge in each cross-communication edge is cut, to ensure that semantic information in the computational graph can be retained to a maximum extent in a subsequently constructed bipartite graph.

When the cross-communication edges respectively corresponding to the M communication nodes are cut, either of the following two manners may be used to perform the cutting. In a global optimal cutting manner and a local optimal cutting manner, after grouping, when each group of cross-communication edges includes cross-communication edges of a common subedge, a cutting manner thereof is the same as a cutting manner of the E cross-communication edges; and when a group obtained through grouping includes only one cross-communication edge, a cutting manner of the cross-communication edge is the same as a cutting manner of the i^{th} cross-communication edge.

### (1) Global Optimal Cutting

The N cross-communication edges are separately grouped in L grouping manners, and each grouping manner corresponds to one weight coefficient and one cutting manner of cross-communication edges. After grouping is performed in any one of the L grouping manners, at least one group of cross-communication edges is obtained. Each of the at least one group of cross-communication edges includes at least one common subedge, and each group includes at least one cross-communication edge. A difference between the L grouping manners lies in that common subedges used during grouping in different grouping manners are different.

The following uses an a^{th} grouping manner in the L grouping manners as an example to describe a process of determining a weight coefficient corresponding to the a^{th} grouping manner. In the a^{th} grouping manner, the N cross-communication edges are grouped into A groups. When each group of cross-communication edges is cut, one subedge is cut for each cross-communication edge in the group, so that a sum of weight coefficients respectively corresponding to all subedges cut in the group is the largest or the smallest, and the obtained sum of the weight coefficients is used as a weight coefficient of the group of cross-communication edges. According to the foregoing steps, A weight coefficients respectively corresponding to the A groups of cross-communication edges may be obtained through computing, and then the A weight coefficients are added to obtain a weight coefficient corresponding to the a^{th} grouping manner.

According to the foregoing steps, L weight coefficients respectively corresponding to the L grouping manners may be obtained, and a cross-communication edge cutting manner corresponding to a largest or smallest weight coefficient in the L weight coefficients is used as a cutting manner of the computational graph, that is, the global optimal cutting manner.

### (2) Local Optimal Cutting

Cross-communication edges corresponding to each of the M communication nodes are sequentially cut. During the cutting, a sequence of the communication nodes is not limited.

B cross-communication edges corresponding to a b^{th} communication node are found, and the B cross-communication edges do not include a cross-communication edge that has been cut. According to the global optimal cutting manner, an optimal cutting manner for the B cross-communication edges is selected. In this cutting manner, a sum of weight coefficients respectively corresponding to all subedges cut in the B cross-communication edges is the largest or the smallest.

After the B cross-communication edges corresponding to the b^{th} communication node are cut, cross-communication edges corresponding to a (b+1)^{th} communication node start to be cut until cutting is completed for the M communication nodes.

It should be understood that, in this manner, optimal cutting can be achieved when cross-communication edges corresponding to each communication node are cut. The user may select the global optimal cutting manner or the local optimal cutting manner based on a specific scenario to cut the cross-communication edges in the computational graph.

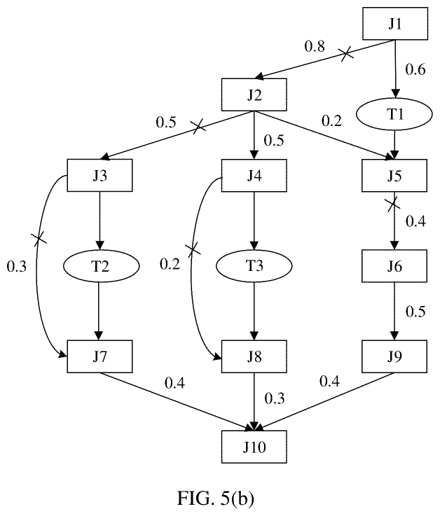

The following uses FIG. 5(a) and FIG. 5(b) as an example to describe a process of cutting a cross-communication edge in the global optimal cutting manner. In the example, a larger weight coefficient indicates higher importance of a corresponding subedge. A computational graph in FIG. 5(a) and FIG. 5(b) is the same as the computational graph in FIG. 4.

FIG. 5(a) and FIG. 5(b) are schematic diagrams of a cross-communication edge cutting manner according to an embodiment of this application. FIG. 5(a) and FIG. 5(b) show two cross-communication edge cutting manners respectively corresponding to two different grouping manners when global optimal cutting is performed. It should be understood that, when the global optimal cutting manner in the example computational graph is searching for, a cutting manner corresponding to another grouping manner is further searched for. Examples are not listed herein.

In FIG. 5(a), 17 cross-communication edges in the computational graph are grouped into 3 groups. A first group includes a common subedge: J3-J7, and includes cross-communication edges: J3-J7, J2-J3-J7, J2-J3-J7-J10, J3-J7-J10, and J1-J2-J3-J7-J10. A second group includes a common subedge: J4-J8, and includes cross-communication edges: J4-J8, J2-J4-J8, J1-J2-J4-J8, J4-J8-J10, J2-J4-J8-J10, and J1-J2-J4-J8-J10. A third group includes a common subedge: J2-J5, and includes cross-communication edges: J1-J2-J5, J1-J2-J5-J6, J1-J2-J5-J6-J9, J1-J2-J5-J6-J9-J10, J2-J5-J6-J9-J10, and J1-J2-J5-J6-J9-J10. The three groups of cross-communication edges are cut separately, so that a sum of weight coefficients respectively corresponding to all subedges cut in each group of cross-communication edges is the smallest.

In this case, when a subedge cut in the first group of cross-communication edges is J3-J7, a sum of weight coefficients of all subedges cut in the first group of cross-communication edges may be the smallest, and a corresponding weight coefficient of the first group of cross-communication edges after the cutting is 0.3. When a subedge cut in the second group of cross-communication edges is J4-J8, a sum of weight coefficients of all subedges cut in the second group of cross-communication edges may be the smallest, and a corresponding weight coefficient of the second group of cross-communication edges after the cutting is 0.2. When a subedge cut in the third group of cross-communication edges is J2-J5, a sum of weight coefficients of all subedges cut in the third group of cross-communication edges may be the smallest, and a corresponding weight coefficient of the third group of cross-communication edges after the cutting is 0.2. In conclusion, in the cross-communication edge cutting manner corresponding to the grouping manner shown in FIG. 5(a), a sum of the weight coefficients of all the cut subedges is 0.7

In FIG. 5(b), 17 cross-communication edges in the computational graph are grouped into 5 groups. A first group includes a common subedge: J3-J7, and includes cross-communication edges: J3-J7 and J3-J7-J10. A second group includes a common subedge: J4-J8, and includes cross-communication edges: J4-J8, J2-J4-J8, J1-J2-J4-J8, J4-J8-J10, J2-J4-J8-J10, and J1-J2-J4-J8-J10. A third group includes a common subedge: J1-J2, and includes cross-communication edges: J1-J2-J5, J1-J2-J5-J6, J1-J2-J5-J6-J9, and J1-J2-J5-J6-J9-J10. A fourth group includes a common subedge: J5-J6, and includes cross-communication edges: J2-J5-J6-J9-J10 and J1-J2-J5-J6-J9-J10. A fifth group includes a common subedge: J2-J3, and includes cross-communication edges: J2-J3-J7, J2-J3-J7-J10, and J1-J2-J3-J7-J10.

In this case, when a subedge cut in the first group of cross-communication edges is J3-J7, a sum of weight coefficients of all subedges cut in the first group of cross-communication edges may be the smallest, and a corresponding weight coefficient of the first group of cross-communication edges after the cutting is 0.3. When a subedge cut in the second group of cross-communication edges is J4-J8, a sum of weight coefficients of all subedges cut in the second group of cross-communication edges may be the smallest, and a corresponding weight coefficient of the second group of cross-communication edges after the cutting is 0.2. When a subedge cut in the third group of cross-communication edges is J1-J2, a sum of weight coefficients of all subedges cut in the third group of cross-communication edges may be the smallest, and a corresponding weight coefficient of the third group of cross-communication edges after the cutting is 0.8. When a subedge cut in the fourth group of cross-communication edges is J5-J6, a sum of weight coefficients of all subedges cut in the fourth group of cross-communication edges may be the smallest, and a corresponding weight coefficient of the fourth group of cross-communication edges after the cutting is 0.4. When a subedge cut in the fifth group of cross-communication edges is J2-J3, a sum of weight coefficients of all subedges cut in the fifth group of cross-communication edges may be the smallest, and a corresponding weight coefficient of the fifth group of cross-communication edges after the cutting is 0.5.

In conclusion, in the cross-communication edge cutting manner corresponding to the grouping manner shown in FIG. 5(b), a sum of the weight coefficients of all the cut subedges is 2.2 The sum of the weight coefficients of all the cut subedges in FIG. 5(a) is less than the sum of the weight coefficients of all the cut subedges in FIG. 5(b). Therefore, the cross-communication edge cutting manner in FIG. 5(a) is better.

It should be understood that, although FIG. 5(a) and FIG. 5(b) show only two cross-communication edge cutting manners in pursuit of global optimization, it can be learned that, in FIG. 5(a), a quantity of cut subedges is the smallest, and the sum of the weight coefficients corresponding to the cut subedges is also the smallest. In this case, the cross-communication edge cutting manner in FIG. 5(a) may be used as the global optimal cutting manner of the computational graph.

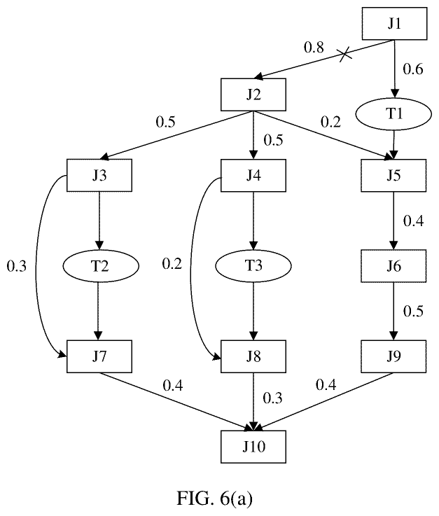

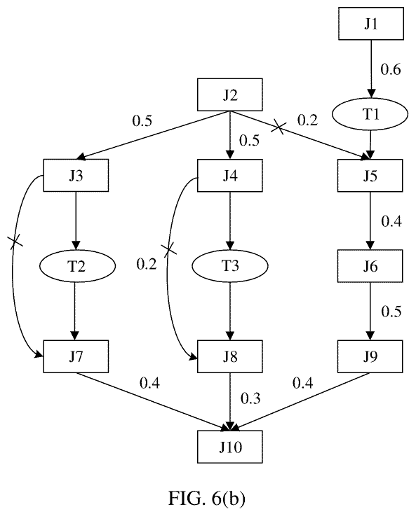

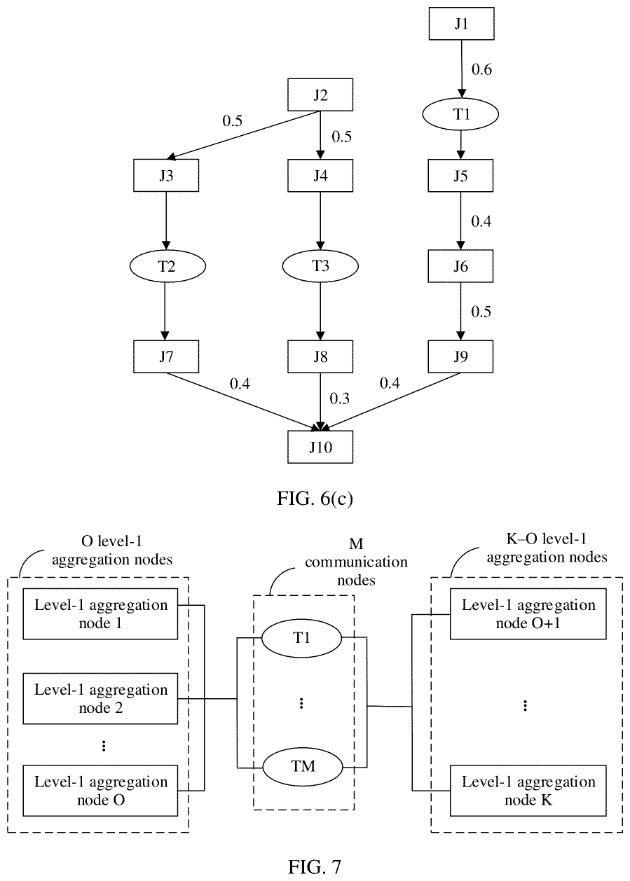

The following uses FIG. 6(a) to FIG. 6(c) as an example to describe a process of cutting a cross-communication edge in the local optimal cutting manner. In the example, a larger weight coefficient indicates higher importance of a corresponding subedge. A computational graph in FIG. 6(a) to FIG. 6(c) is the same as the computational graph in FIG. 4.

FIG. 6(a) to FIG. 6(c) are schematic diagrams of another cross-communication edge cutting manner according to an embodiment of this application. FIG. 6(a) and FIG. 6(c) each show a process of sequentially cutting cross-communication edges corresponding to each communication node in a sequence of a communication node T1 to a communication node T2 to a communication node T3. It should be understood that the cutting sequence in FIG. 6(a) to FIG. 6(c) is merely a specific example. Alternatively, a person skilled in the art may sequentially cut, in another sequence, the cross-communication edges corresponding to each communication node. This is not limited in this application.

FIG. 6(a) shows a process of cutting the cross-communication edges corresponding to the communication node T1. There are a total of six cross-communication edges corresponding to the communication node T1, including J1-J2-J5, J1-J2-J5-J6, J1-J2-J5-J6-J9, J1-J2-J5-J6-J9-J10, J1-J2-J4-J8-J10, and J1-J2-J3-J7-J10. The six cross-communication edges are cut, so that a sum of weight coefficients respectively corresponding to all cut subedges is the smallest. It can be learned that the six cross-communication edges include a common subedge J1-J2. Therefore, when the subedge J1-J2 is cut, a sum of weight coefficients is the smallest, and is 0.8.

FIG. 6(b) shows a process of cutting the cross-communication edges corresponding to the communication node T2 after the cross-communication edges corresponding to the communication node T1 are cut. In this case, there are a total of six cross-communication edges corresponding to the communication node T2, including J3-J7, J3-J7-J10, J2-J3-J7, J2-J3-J7-J10, J2-J4-J8-J10, and J2-J5-J6-J9-J10. According to the global optimal cutting manner in the foregoing embodiments, an optimal cutting manner for the six cross-communication edges is found, so that a sum of weight coefficients of all subedges cut in the six cross-communication edges is the smallest. It is easy to understand that the six cross-communication edges can be grouped into three groups. A first group includes four cross-communication edges: J3-J7, J3-J7-J10, J2-J3-J7, and J2-J3-J7-J10, and includes a common subedge J3-J7. The second group includes a cross-communication edge J2-J4-J8-J10. The third group includes a cross-communication edge J2-J5-J6-J9-J10. In this case, when a subedge cut in the first group of cross-communication edges is J3-J7, a sum of weight coefficients of all subedges cut in the first group of cross-communication edges may be the smallest, and a corresponding weight coefficient of the first group of cross-communication edges after the cutting is 0.3. When a subedge cut in the second group of cross-communication edges is J4-J8, a sum of weight coefficients of all subedges cut in the second group of cross-communication edges may be the smallest, and a corresponding weight coefficient of the second group of cross-communication edges after the cutting is 0.2. When a subedge cut in the third group of cross-communication edges is J2-J5, a sum of weight coefficients of all subedges cut in the third group of cross-communication edges may be the smallest, and a corresponding weight coefficient of the third group of cross-communication edges after the cutting is 0.2. In this global optimal cutting manner, a sum of the weight coefficients respectively corresponding to all the cut subedges is 0.7.

FIG. 6(c) shows a computational graph obtained after the cross-communication edges corresponding to the communication node T2 are cut. It can be learned that the cross-communication edges corresponding to the communication node T3 have been completely cut in the foregoing process. Therefore, FIG. 6(c) is a computational graph obtained after cutting is performed in a local optimal cutting manner. When cutting is performed in the local optimal cutting manner, a sum of weights corresponding to all cut subedges is 1.5.

In conclusion, it can be learned from the global optimal cutting manner shown in FIG. 5(a) and FIG. 5(b) and the local optimal cutting manner shown in FIG. 6(a) to FIG. 6(c) that, a sum of weight coefficients corresponding to all cut subedges when global optimal cutting is performed is less than a sum of weight coefficients corresponding to all cut subedges when local optimal cutting is performed, and through global optimal cutting, semantic information in the computational graph can be retained to a maximum extent.

In a feasible implementation, after the cross-communication edges are cut, all the cut subedges are marked. In this way, in a subsequent process of displaying the constructed bipartite graph by the user, when the user moves an operation button such as a cursor on a user interface to a computation node for which a subedge is cut, the cut subedge for the computation node is displayed.

In a feasible implementation, the computational graph after cutting includes K connected blocks, where K is a positive integer; and the performing an aggregation operation to obtain the bipartite graph includes: separately aggregating the K connected blocks in the computational graph after the cutting to obtain the bipartite graph. The K connected blocks are obtained by grouping computation nodes in the computational graph based on positions of the M communication nodes in the computational graph, the bipartite graph includes K level-1 aggregation nodes and the M communication nodes, any two of the K level-1 aggregation nodes are directly connected without an edge, and the K level-1 aggregation nodes respectively belong to K name scopes.

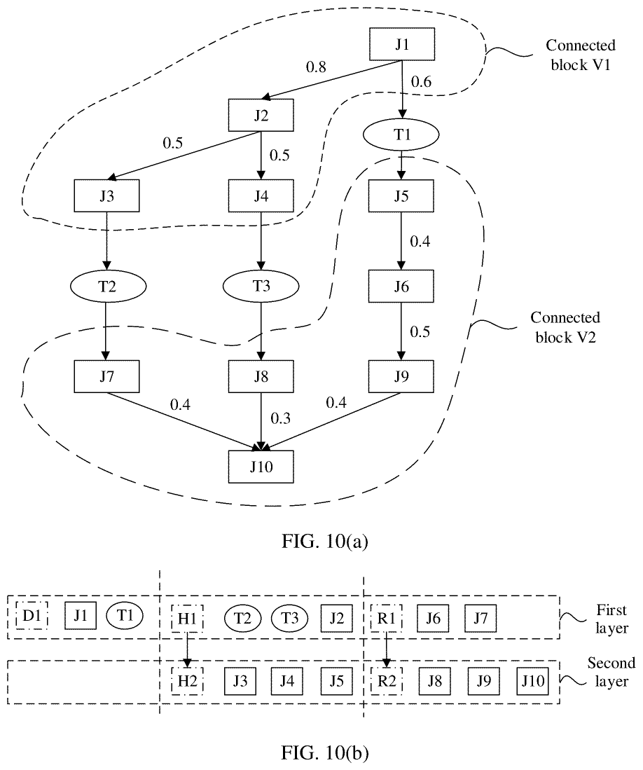

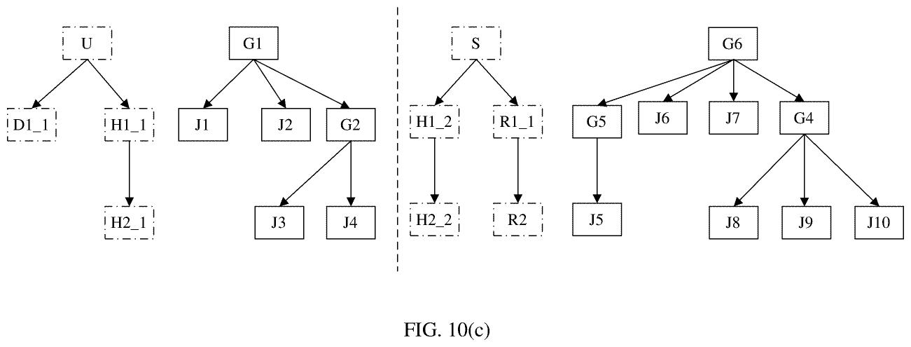

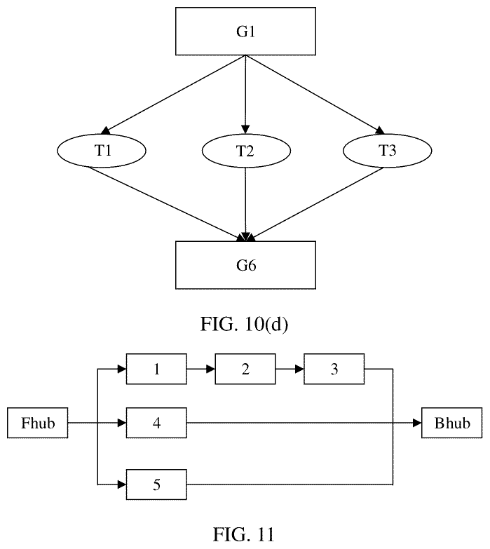

The computation nodes in the computational graph after the cutting are separated by a barrier that includes the M communication nodes, to form K connected blocks. Each of the K connected blocks includes at least one computation node. For details, refer to detailed descriptions of embodiments shown in FIG. 10(a) to FIG. 10(d) below.

FIG. 7 is a schematic diagram of a structure of a bipartite graph according to an embodiment of this application. As shown in FIG. 7, the bipartite graph constructed based on the computational graph includes K level-1 aggregation nodes and the M communication nodes. All nodes in the bipartite graph may be divided into two sets. One set includes all communication nodes, the other set includes all level-1 aggregation nodes, and any two nodes in either of the two sets are directly connected without an edge. As shown in FIG. 7, any two of the K level-1 aggregation nodes are directly connected without an edge, and any two of the M communication nodes are directly connected without an edge. O level-1 aggregation nodes communicate with K—O level-1 aggregation nodes through the communication nodes. The separately aggregating the K connected blocks in the computational graph after the cutting to obtain the bipartite graph specifically includes: aggregating each connected block based on a hierarchical structure of name scopes to which computation nodes in each connected block belong, to obtain one level-1 aggregation node corresponding to each connected block. A total of K level-1 aggregation nodes are obtained. In addition, K corresponding name scopes are respectively constructed for the K level-1 aggregation nodes. That is, the K level-1 aggregation nodes respectively belong to the K name scopes.

The following uses a first connected block in the K connected blocks as an example to describe a process of aggregating the first connected block based on a hierarchical structure of name scopes to which computation nodes in the first connected block belong. The nodes in the first connected block belong to Z groups of name scopes that are of a hierarchical structure, where Z is a positive integer.

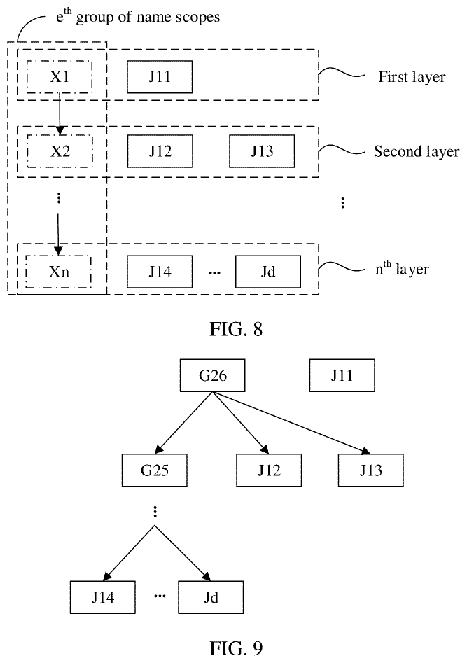

The following uses an e^{th} group of name scopes as an example to describe a process of aggregating a computation node based on a hierarchical structure of the e^{th} group of name scopes. Specifically, FIG. 8 is a schematic diagram of a hierarchical structure of name scopes according to an embodiment of this application. As shown in FIG. 8, the e^{th} group of name scopes has n name scopes, which are X1, X2, . . . , and Xn, respectively. The n name scopes are of a hierarchical structure that can be expanded layer by layer. The name scope X1 includes the name scope X2, . . . , and the name scope Xn−1 includes the name scope Xn. A computation node J11 belongs to the name scope X1, computation nodes J12 and J13 belong to the name scope X2, and computation nodes J14, . . . , and Jd belong to the name scope Xn.

Then, the computation nodes included in the e^{th} group of name scopes are aggregated layer by layer based on the hierarchical structure of the name scopes. Specifically, FIG. 9 is a schematic diagram of a process of aggregating computation nodes based on a hierarchical structure of name scopes according to an embodiment of this application. As shown in FIG. 9, starting from a name scope at an n^{th} layer, the computation nodes (J14, . . . , and Jd) that belong to the name scope at the n^{th} layer are aggregated. Then, an obtained aggregation node is aggregated with computation nodes that belong to a name scope at an (n−1)^{th} layer. Aggregation is performed layer by layer according to this rule. After nodes that belong to a name scope at a third layer are aggregated, an aggregation node G25 is obtained. The aggregation node G25 is aggregated with computation nodes that belong to a name scope at a second layer, to obtain an aggregation node G26. That is, after the computation nodes included in the e^{th} group of name scopes are aggregated, the aggregation node G26 and the computation node J11 are obtained. It should be noted that, in a node aggregation process, a corresponding name scope is also created for an aggregation node. As shown in FIG. 9, a name scope created for the aggregation node G26 is Xg26, and a name scope created for the aggregation node G25 is Xg25. Both the name scope Xg26 and the name scope X1 are the name scopes at the first layer, and both the name scope Xg25 and the name scope X2 are the name scopes at the second layer.

According to the process of aggregating the computation nodes included in the e^{th} group of name scopes, computation nodes included in each group of name scopes are aggregated, to obtain Z groups of aggregation results. Nodes included in the Z groups of aggregation results belong to a same layer. Finally, the Z groups of aggregation results are aggregated to obtain a level-1 aggregation node corresponding to the first connected block, and a corresponding name scope is also created for the level-1 aggregation node.

Similarly, each of the K connected blocks may be aggregated with reference to the aggregation manner of the first connected block, to obtain K level-1 aggregation nodes.

In a feasible implementation, each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes. The nodes at the j^{th} layer include the aggregation node and/or the computation node, and the computation node is a node that cannot be expanded.

It can be learned from the process of aggregating the first connected block that, each level-1 aggregation node is of a hierarchical structure, and nodes at each layer in the hierarchical structure are obtained by expanding an aggregation node at an upper layer. The level-1 aggregation node is a first layer in the hierarchical structure thereof, that is, an uppermost layer in the hierarchical structure. Expanding is an inverse process of aggregation. Aggregation means that a graph structure represented by at least one node and an edge between the at least one node is represented by using one node. Expanding means that a node is represented by using a graph structure that includes at least one node and an edge between the at least one node.

Nodes at each layer in the hierarchical structure belong to different name scopes, and the different name scopes belong to a same layer in the hierarchical structure of the name scopes. Nodes at each layer may include only an aggregation node, or include only a computation node, or include an aggregation node and a computation node.

The aggregation node is a node that can be expanded, and the computation node is a minimum unit that cannot be expanded in the computational graph.

In a feasible implementation, the method further includes: updating a first name scope when a subedge between a first computation node and a second computation node in the first name scope is cut, where the first name scope is a name scope in the computational graph; and constructing a name scope that includes the first computation node, where the first computation node does not belong to an updated first name scope.

The first name scope is any name scope in the computational graph. The first computation node and the second computation node are any two computation nodes in the first name scope.

Specifically, after the cross-communication edge in the computational graph is cut, the subedge between the first computation node and the second computation node is cut. In this case, the first computation node and the second computation node belong to different connected blocks after cutting is performed in the computational graph. After the cutting, the first computation node does not belong to the first name scope, and the second computation node still belongs to the first name scope. In this case, because a quantity of computation nodes in the first name scope changes, an attribute corresponding to the first name scope may be updated, including an identifier of the first name scope, a quantity of included computation nodes, and the like. In addition, a corresponding name scope may be constructed for the first computation node, and a hierarchical structure of the name scope constructed for the first computation node is the same as a hierarchical structure of the name scope to which the second computation node belongs. For example, if the second computation node belongs to a third name scope in three-layer name scopes, a three-layer name scope may be constructed for the first computation node, and the first computation node belongs to a name scope at a third layer in the three-layer name scopes. In this case, identifiers of the name scopes to which the first computation node and the second computation node belong are different.

Optionally, an identifier of a name scope may be represented by a letter, a digit, a combination of a letter and a digit, or another character. This is not limited in this application.

The following uses FIG. 10(a) to FIG. 10(d) as an example to describe in detail a process of aggregating connected blocks in a computational graph after across-communication edges are cut to obtain a corresponding bipartite graph.

FIG. 10(a) to FIG. 10(d) are example diagrams of a process of aggregating connected blocks according to an embodiment of this application.

FIG. 10(a) shows a computational graph obtained after cross-communication edges are cut. FIG. 10(a) shows a result obtained after cutting is performed in the global optimal cutting manner in FIG. 5(a). As shown in FIG. 10(a), after cutting is performed in the computational graph, all computation nodes are separated by communication nodes, to form two connected blocks: V1 and V2. In other words, the computational graph after the cutting includes two connected blocks (V1 and V2) and three communication nodes (T1, T2, and T3).

FIG. 10(b) shows a hierarchical structure of name scopes in a computational graph and a name scope to which each node belongs. As shown in FIG. 10(b), the hierarchical structure of the name scope corresponding to the computational graph has two layers. Name scopes at a first layer include a name scope D1, a name scope H1, and a name scope R1. The name scope D1 has no sub-name scope, the name scope H1 includes a name scope H2, and the name scope R1 includes a name scope R2. In other words, the name scope H2 and the name scope R2 are sub-name scopes of the name scope H1 and the name scope R1, respectively. The computation node J1 and the communication node T1 belong to the name scope D1. The communication node T2, the communication node T3, and the computation node J2 belong to the name scope H1. The computation node J3, the computation node J4, and the computation node J5 belong to the name scope H2. The computation node J6 and the computation node J7 belong to the name scope R1. The computation node J8, the computation node J9, and the computation node J10 belong to the name scope R2.

FIG. 10(c) shows a process of aggregating the connected blocks V1 and V2 in FIG. 10(a). A dashed-line-box tree diagram represents a hierarchical structure of name scopes, and a solid-line-box tree diagram represents a hierarchical structure of level-1 aggregation nodes.

In a process of aggregating the connected block V1, the computation node J5 is cut out of the name scope H2. In this case, an identifier of the name scope H2 may be updated to H2_1, and the computation node J3 and the computation node J4 belong to the name scope H2_1. In this case, the connected block V1 corresponds to two groups of name scopes of the hierarchical structure, which are D1 and H1-H2, respectively. Aggregation is performed based on the hierarchical structure of the name scopes. First, the computation node J3 and the computation node J4 are aggregated into an aggregation node G2, and the aggregation node G2 belongs to the name scope H1. Because a quantity of nodes in H1 changes, an identifier of the name scope H1 may be updated to H1_1. Finally, three nodes (the computation node J1, the computation node J2, and the aggregation node G2) that belong to name scopes at a first layer are aggregated, to obtain a level-1 aggregation node G1 corresponding to the connected block V1, and construct a corresponding name scope U for the level-1 aggregation node G1.

In a process of aggregating the connected blocks V2, after the cross-communication edges are cut, the computation node J5 does not belong to the name scope H2. In this case, a new hierarchical name scope, namely, a two-layer name scope H1_2-H2_2, may be constructed based on the name scope corresponding to the computation node J5 before the cutting, and the computation node J5 belongs to a name scope H2_2. In this case, the connected block V2 corresponds to two groups of name scopes of a hierarchical structure, which are H1_2-H2_2 and R1-R2, respectively. Aggregation is performed based on the hierarchical structure of the name scopes. First, the computation node J8, the computation node J9, and the computation node J10 are aggregated into an aggregation node G4, and the aggregation node G4, the computation node J6, and the computation node J7 all belong to the name scope R1. In this case, an identifier of the name scope R1 may be updated to R1_1. In addition, the computation node J5 is aggregated to obtain an aggregation node G5, and the aggregation node G5 belongs to a name scope H1_2. Finally, four nodes (the aggregation node G5, the aggregation node G4, the computation node J6, and the computation node J7) that belong to name scopes at a same layer are aggregated, to obtain a level-1 aggregation node G6 corresponding to the connected block V2, and construct a corresponding name scope S for the level-1 aggregation node G6.

FIG. 10(d) shows a bipartite graph obtained after the connected blocks are aggregated. As shown in FIG. 10(d), the level-1 aggregation node G1 is obtained after the connected block V1 is aggregated, and the level-1 aggregation node G6 is obtained after the connected block V2 is aggregated. G1 and G6 communicate with each other through the three communication nodes (T1, T2, and T3). Any two of the three communication nodes are directly connected without an edge, and the two level-1 aggregation nodes are also directly connected without an edge.

In a feasible implementation, the method further includes: computing a hash value of the aggregation node and a hash value of the computation node in the bipartite graph. When the node is the aggregation node, a hash value of the node is equal to a sum of hash values of all nodes obtained by expanding the aggregation node; or when the node is the computation node, a hash value of the node is determined by an attribute of the computation node, where the attribute of the computation node includes a type, an in-degree, an out-degree, a type of an auxiliary node, and a quantity of auxiliary nodes of the computation node.

The computing a hash value of the aggregation node and a hash value of the computation node in a hierarchical structure of the level-1 aggregation nodes includes: from bottom to top layer by layer in the hierarchical structure, sequentially computing hash values corresponding to all nodes at each layer until hash values of the level-1 aggregation nodes are finally obtained through computing. For an aggregation node, a hash value of the aggregation node is equal to a sum of hash values of all nodes obtained by expanding the aggregation node once. For a computation node, a hash value of the computation node is determined by an attribute of the computation node.

Optionally, the attribute of the computation node includes a type, an in-degree, and an out-degree, a type of an auxiliary node, a quantity of auxiliary nodes, and the like of the computation node. This is not limited in this application. Further, optionally, the type of the computation node is represented by an identifier of the node. For example, an Add node is represented by add, and a Reduce node is represented by reduce. The in-degree of the computation node is a quantity of edges in which data directly flows into the computation node. The out-degree is a quantity of edges in which data directly flows into after flowing out of the computation node. The auxiliary node of the computation node is a node whose data is input only to the computation node, and the auxiliary node has no data input. The type of the auxiliary node may be a constant or a variable, which may be represented by using character strings Const and Para, respectively. This is not limited in this application.

Optionally, in a process of determining the hash value corresponding to the computation node, character strings that represent an attribute of each computation node may be concatenated to obtain a character string. Then, the character string is mapped to a corresponding hash value by using a DJB hash algorithm (or referred to as a Times33 algorithm) or the like.

In a feasible implementation, the method further includes: displaying a plurality of nodes in the bipartite graph in a stacked manner. The plurality of nodes are obtained by expanding the same aggregation node once, hash values of the plurality of nodes are the same, and the plurality of nodes are connected in serial or parallel. Optionally, displaying in a stacked manner means that, in the bipartite graph, a stack structure that includes a connection relationship identifier and a quantity identifier is used to display the plurality of nodes that meet the foregoing condition. The connection relationship identifier represents a connection relationship between the plurality of nodes, for example, a parallel connection or a serial connection. The quantity identifier indicates a quantity of the plurality of nodes that meet the foregoing condition. The foregoing condition means the plurality of nodes that are obtained by expanding the same aggregation node once, that have a same hash value, and whose connection relationship is a serial connection or a parallel connection.

Specifically, each level-1 aggregation node is detected layer by layer in an order from an upper layer to a lower layer (that is, starting from a first layer in the hierarchical structure). When a quantity of nodes obtained by expanding a first aggregation node is greater than or equal to a preset quantity, isomorphism detection is performed on the nodes obtained after the expansion. Specifically, whether there are nodes with a same hash value in the nodes obtained after the expansion is detected. The first aggregation node is an aggregation node at any layer in the hierarchical structure of the level-1 aggregation nodes.

When it is detected that there are a plurality of nodes with a same hash value in the nodes after the expansion, and a connection relationship between the plurality of nodes is a parallel connection or a serial connection, the plurality of nodes are displayed in a stacked manner. The plurality of nodes with the same hash value are used as nodes with a same internal structure. The serial connection means that the plurality of nodes are sequentially connected, and there is only one communication path between a node at which a data flow starts and a node at which a data flow ends. The parallel connection means that input data flows of all nodes in the plurality of nodes flow out of a same node without passing through any intermediate node, and output data flows of all nodes in the plurality of nodes flow into a same node without passing through any intermediate node. Optionally, the user may perform an operation such as double-clicking or clicking on the same aggregation node, to expand the same aggregation node. After the same aggregation node is expanded, a plurality of nodes displayed in a stacked manner are obtained. Through displaying in a stacked manner, when the user visualizes the bipartite graph, a hierarchical structure of the aggregation node can be simplified, and user interface space can be reduced, so that the user can more quickly understand an internal structure of the aggregation node.

FIG. 11 is a schematic diagram of a structure of a serial connection and a parallel connection of nodes according to an embodiment of this application. As shown in FIG. 11, nodes 1 to 5 are five nodes with a same hash value, namely, isomorphic nodes. During detection of a serial structure, edges connected to the five nodes are traversed, and it is detected that there is only one communication path between the node 1 and the node 3. To be specific, the node 1, the node 2, and the node 3 are three serial nodes, and the three nodes may be displayed in a stacked manner. During detection of a parallel structure, the node 4 and the node 5 are used as start points to perform forward search and backward search, respectively. During the forward search, it is found that the node 4 and the node 5 are aggregated to an aggregation node Fhub. During the backward search, it is found that the node 4 and the node 5 are aggregated to an aggregation node Bhub. In this case, the node 4 and the node 5 are connected in parallel, and the node 4 and the node 5 may also be displayed in a stacked manner.

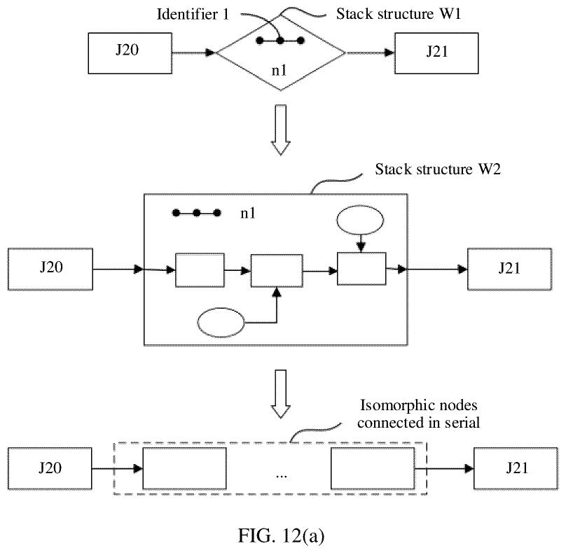

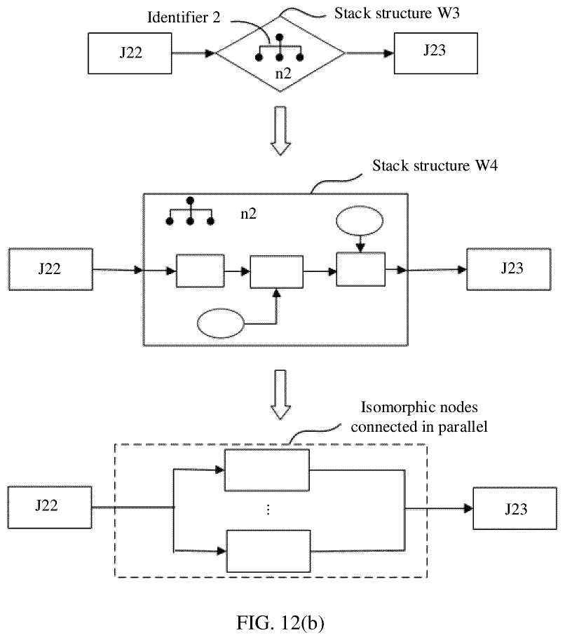

FIG. 12(a) and FIG. 12(b) are schematic diagrams of a process of expanding stacked aggregation nodes according to an embodiment of this application.

FIG. 12(a) is a schematic diagram of a visualized process of expanding aggregation nodes stacked in a serial structure. As shown in FIG. 12(a), a node J20, a stack structure W1, and a node J21 may be an expansion result obtained by expanding a second aggregation node once, and the second aggregation node may be a node at any layer of any level-1 aggregation node. Because the nodes obtained by expanding the second aggregation node include substructures (that is, nodes with a same hash value) that can be stacked, the stack structure W1 may be used for displaying. An identifier 1 in the stack structure W1 is a connection relationship identifier, indicating that nodes stacked in the stack structure W1 are of a serial structure, and a digit n1 in the stack structure W1 indicates a quantity of isomorphic nodes that are stacked. The user may perform an operation such as clicking or double-clicking to further expand the stack structure W1 to obtain a stack structure W2. The stack structure W2 may display an internal structure of a single isomorphic node. The user may further expand the stack structure W2 to obtain a fully expanded schematic diagram of the stack structure W2, that is, display an actual connection relationship of n1 isomorphic nodes connected in serial. In a visualized process, the isomorphic nodes connected in serial may be displayed in a same color.

FIG. 12(b) is a schematic diagram of a visualized process of expanding aggregation nodes stacked in a parallel structure. As shown in FIG. 12(b), a node J22, a stack structure W3, and a node J23 may be an expansion result obtained by expanding a third aggregation node once, and the third aggregation node may be a node at any layer of any level-1 aggregation node. Because the nodes obtained by expanding the third aggregation node include substructures (that is, nodes with a same hash value) that can be stacked, the stack structure W3 may be used for displaying. An identifier 2 in the stack structure W3 is a connection relationship identifier, indicating that nodes stacked in the stack structure W3 are of a parallel structure, and a digit n2 in the stack structure W3 indicates a quantity of isomorphic nodes that are stacked. The user may perform an operation such as clicking or double-clicking to further expand the stack structure W3 to obtain a stack structure W4. The stack structure W4 may display an internal structure of a single isomorphic node. The user may further expand the stack structure W4 to obtain a fully expanded schematic diagram of the stack structure W4, that is, display an actual connection relationship of n2 isomorphic nodes connected in parallel. In a visualized process, the isomorphic nodes connected in parallel may be displayed in a same color.

It should be understood that, in an actual application process, another connection relationship identifier may alternatively be used to represent stacking of a serial connection and a parallel connection. This is not limited in this application.

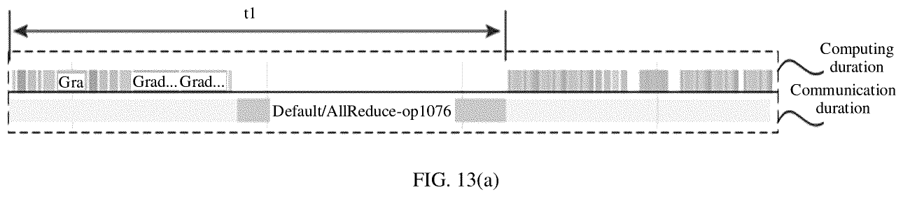

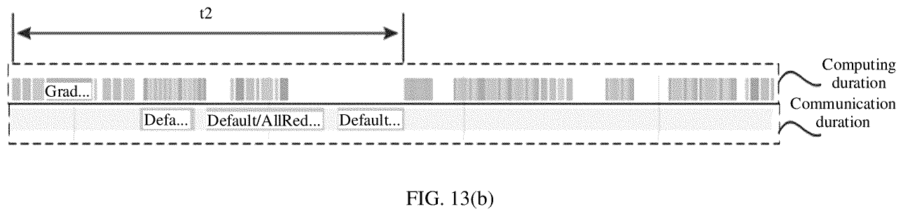

FIG. 13(a) and FIG. 13(b) show examples of timelines of a model training process according to an embodiment of this application. In an actual application process, the user may construct a bipartite graph for various deep learning tasks based on this solution. The bipartite graph can clearly display a structure of a model, so that the user can quickly locate the communication node and specify a function of the communication node a communication node based on the bipartite graph, and formulate a fusion/grouping policy of the communication node, to reduce communication duration in the training process as much as possible.

In a possible scenario, the user may view a timeline (Timeline) corresponding to the model training process, observe an overlap between communication time and computing time, find a communication node whose communication time and computing time do not overlap, quickly locate the communication node in the bipartite graph constructed based on this solution, and analyze a function of the communication node based on a specific structure of the computational graph, to formulate an appropriate fusion/grouping policy of the communication node, so that duration of a model training process corresponding to different deep learning tasks is reduced.

For example, when a residual network ResNet-50 is trained by using MindSpore, it is found that, in a timeline corresponding to a training process, there is no overlap (overlap) between communication duration of a communication node AllReduce and computing duration corresponding to the computation node, and iterative hangover time is relatively long. In the timeline shown in FIG. 13(a), a first layer is computing duration corresponding to the computation node, and a second layer is communication duration corresponding to the communication node. After the training process corresponding to the residual network is constructed into a corresponding bipartite graph, it can be quickly and clearly discovered that the framework automatically fuses all 162 communication nodes AllReduce used for backward gradient aggregation into one node. Therefore, the communication duration and the computing duration in the timeline do not overlap. In this case, the fused communication nodes are grouped, first 55 communication nodes are fused into one, 55^{th} to 108^{th} communication nodes are fused into one, and 109^{th} to 162^{nd} communication nodes are fused into one. Training is performed again, to obtain a training process timeline, as shown in FIG. 13(b). It can be learned that, after the communication nodes are grouped, computing duration and communication duration overlap. In addition, compared with time consumed t1 in a gradient computation and fusion process before the communication nodes are grouped, time consumed t2 in a gradient computation and fusion process after the communication nodes are grouped is significantly shortened.

FIG. 14 is a schematic flowchart of a display method for a bipartite graph according to an embodiment of this application. As shown in FIG. 14, the method 1400 includes step S1410.

Step S1410: Input a computational graph, and output the bipartite graph based on the computational graph.

The computational graph includes M communication nodes, a first communication node in the M communication nodes corresponds to P predecessor nodes and Q successor nodes, the first communication node corresponds to at least one cross-communication edge, each of the at least one cross-communication edge indicates a communication path between one of the P predecessor nodes and one of the Q successor nodes, and no cross-communication edge passes through the M communication nodes, where P, Q, and M are positive integers. Cross-communication edges respectively corresponding to the M communication nodes are not connected in the bipartite graph, and any two of the M communication nodes are directly connected without an edge in the bipartite graph.

In a feasible implementation, the computational graph includes C computation nodes, and the bipartite graph includes K level-1 aggregation nodes. The K level-1 aggregation nodes are obtained by aggregating the C computation nodes, each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, where C, K, and j are positive integers. The nodes at the j^{th} layer include the aggregation node and/or the computation node, and the computation node is a node that cannot be expanded.

In a feasible implementation, the bipartite graph includes a stack structure. The stack structure includes a connection relationship identifier and a quantity identifier. The connection relationship identifier represents a connection relationship between a plurality of nodes. The quantity identifier represents a quantity of the plurality of nodes. The plurality of nodes are obtained by expanding the same aggregation node once, hash values of the plurality of nodes are the same, and the connection relationship between the plurality of nodes is a serial connection or a parallel connection.

In a feasible implementation, when the node is the aggregation node, a hash value of the node is equal to a sum of hash values of all nodes obtained by expanding the aggregation node; or when the node is the computation node, a hash value of the node is determined by an attribute of the computation node, where the attribute of the computation node includes a type, an in-degree, an out-degree, a type of an auxiliary node, and a quantity of auxiliary nodes of the computation node.

Specifically, a specific process of obtaining the bipartite graph based on the computational graph in the method embodiment 1400 is the same as a corresponding process in the method embodiment 300. Details are not described herein again.

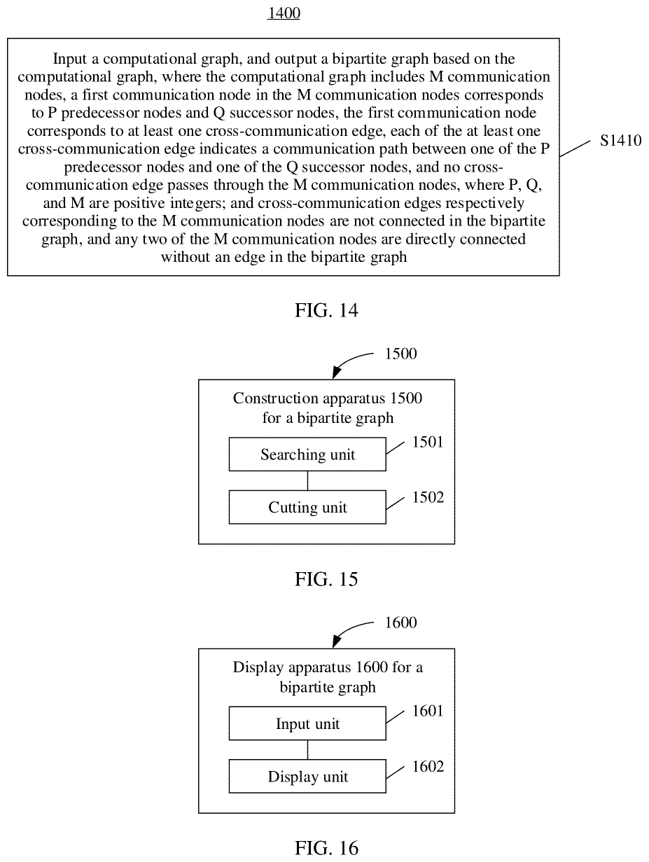

FIG. 15 is a schematic diagram of a structure of a construction apparatus for a bipartite graph according to an embodiment of this application. As shown in FIG. 15, the construction apparatus 1500 for the bipartite graph includes a searching unit 1501 and a cutting unit 1502.

The searching unit 1501 is configured to search a computational graph for at least one cross-communication edge corresponding to a first communication node. The first communication node is one of M communication nodes included in the computational graph, the first communication node corresponds to P predecessor nodes and Q successor nodes, each of the at least one cross-communication edge indicates a communication path between one of the P predecessor nodes and one of the Q successor nodes, and no cross-communication edge passes through the M communication nodes, where M, P, and Q are positive integers. The cutting unit 1502 is configured to cut cross-communication edges respectively corresponding to the M communication nodes, and perform an aggregation operation to obtain the bipartite graph. Any two of the M communication nodes are directly connected without an edge in the bipartite graph.

In a feasible implementation, each cross-communication edge includes at least one subedge, and each of the at least one subedge is directly connected to two computation nodes. Each of the at least one subedge corresponds to one weight coefficient, and the weight coefficient corresponding to each subedge is determined by types of the two computation nodes directly connected to each subedge.

In a feasible implementation, the M communication nodes correspond to a total of N cross-communication edges, where N is a positive integer; and in the aspect of cutting cross-communication edges respectively corresponding to the M communication nodes, the cutting unit 1502 is specifically configured to: cut one subedge in each of the N cross-communication edges. When E cross-communication edges in the N cross-communication edges include a common subedge, a sum of weight coefficients respectively corresponding to all subedges cut in the E cross-communication edges is the largest or the smallest, where E is a positive integer less than or equal to N; or when an i^{th} cross-communication edge and another cross-communication edge in the N cross-communication edges do not include a common subedge, a subedge with a smallest weight coefficient or a largest weight coefficient among subedges included in the i^{th} cross-communication edge is cut, where i is a positive integer.

In a feasible implementation, the computational graph after cutting includes K connected blocks, where K is a positive integer; and in the aspect of performing an aggregation operation to obtain the bipartite graph, the cutting unit 1502 is specifically configured to: separately aggregate the K connected blocks in the computational graph after the cutting to obtain the bipartite graph. The K connected blocks are obtained by grouping computation nodes in the computational graph based on positions of the M communication nodes in the computational graph, the bipartite graph includes K level-1 aggregation nodes and the M communication nodes, any two of the K level-1 aggregation nodes are directly connected without an edge, and the K level-1 aggregation nodes respectively belong to K name scopes.

In a feasible implementation, each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, where j is a positive integer. The nodes at the j^{th} layer include the aggregation node and/or the computation node, and the computation node is a node that cannot be expanded.

In a feasible implementation, the apparatus further includes: an update unit, configured to update a first name scope when a subedge between a first computation node and a second computation node in the first name scope is cut, where the first name scope is a name scope in the computational graph; and a reconstruction unit, configured to construct a name scope that includes the first computation node, where the first computation node does not belong to an updated first name scope.

In a feasible implementation, the apparatus further includes: a computation unit, configured to compute a hash value of the aggregation node and a hash value of the computation node in the bipartite graph. When the node is the aggregation node, a hash value of the node is equal to a sum of hash values of all nodes obtained by expanding the aggregation node; or when the node is the computation node, a hash value of the node is determined by an attribute of the computation node, where the attribute of the computation node includes a type, an in-degree, an out-degree, a type of an auxiliary node, and a quantity of auxiliary nodes of the computation node.

In a feasible implementation, the apparatus further includes: a stacking unit, configured to display a plurality of nodes in the bipartite graph in a stacked manner. The plurality of nodes are obtained by expanding the same aggregation node once, hash values of the plurality of nodes are the same, and the plurality of nodes are connected in serial or parallel.

FIG. 16 is a schematic diagram of a structure of a display apparatus for a bipartite graph according to an embodiment of this application. As shown in FIG. 16, the apparatus 1600 includes an input unit 1601 and a display unit 1602.

The input unit 1601 is configured to input a computational graph. The display unit 1602 is configured to display the bipartite graph based on the computational graph. The computational graph includes M communication nodes, a first communication node in the M communication nodes corresponds to P predecessor nodes and Q successor nodes, the first communication node corresponds to at least one cross-communication edge, each of the at least one cross-communication edge indicates a communication path between one of the P predecessor nodes and one of the Q successor nodes, and no cross-communication edge passes through the M communication nodes, where P, Q, and M are positive integers. Cross-communication edges respectively corresponding to the M communication nodes are not connected in the bipartite graph, and any two of the M communication nodes are directly connected without an edge in the bipartite graph.

In a feasible implementation, the computational graph includes C computation nodes, and the bipartite graph includes K level-1 aggregation nodes. The K level-1 aggregation nodes are obtained by aggregating the C computation nodes, each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, where C, K, and j are positive integers. The nodes at the j^{th} layer include the aggregation node and/or the computation node, and the computation node is a node that cannot be expanded.

The C computation nodes are the computation nodes included in the computational graph in the method embodiment in FIG. 3.

In a feasible implementation, the bipartite graph includes a stack structure. The stack structure includes a connection relationship identifier and a quantity identifier. The connection relationship identifier represents a connection relationship between a plurality of nodes. The quantity identifier represents a quantity of the plurality of nodes. The plurality of nodes are obtained by expanding the same aggregation node once, hash values of the plurality of nodes are the same, and the connection relationship between the plurality of nodes is a serial connection or a parallel connection.

In a feasible implementation, when the node is the aggregation node, a hash value of the node is equal to a sum of hash values of all nodes obtained by expanding the aggregation node; or when the node is the computation node, a hash value of the node is determined by an attribute of the computation node, where the attribute of the computation node includes a type, an in-degree, an out-degree, a type of an auxiliary node, and a quantity of auxiliary nodes of the computation node.

Specifically, a specific process of obtaining the bipartite graph based on the computational graph in the display apparatus 1600 for the bipartite graph is the same as a corresponding display process for the bipartite graph in the method embodiment 1400. Details are not described herein again.

The apparatus 1500 and the apparatus 1600 herein are embodied in a form of functional unit. The term “unit” herein may be an application-specific integrated circuit (application-specific integrated circuit, ASIC), an electronic circuit, a processor (for example, a shared processor, a dedicated processor, or a group processor) configured to execute one or more software or firmware programs and a memory, a combined logic circuit, and/or another suitable component that supports the described function. In an optional example, a person skilled in the art may understand that the apparatus 1500 and the apparatus 1600 may be configured to separately perform the corresponding procedures and/or steps in the method embodiment 300 and the method embodiment 1400. To avoid repetition, details are not described herein again.

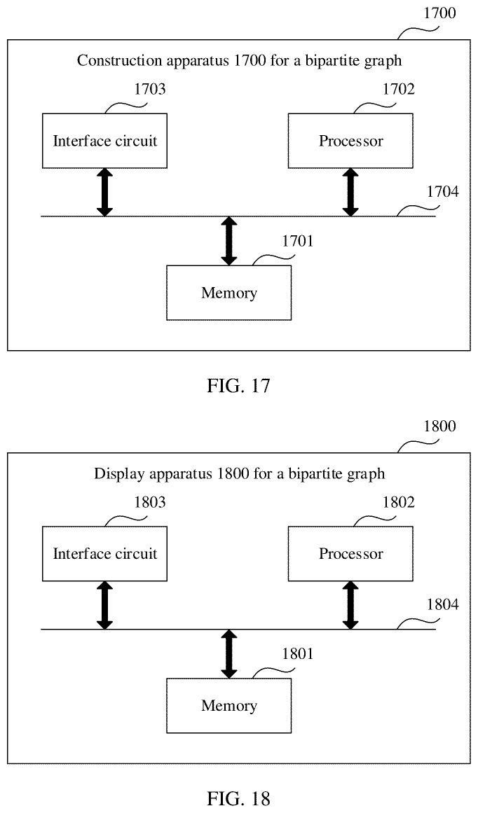

FIG. 17 is a schematic diagram of a hardware structure of a construction apparatus for a bipartite graph according to an embodiment of this application. As shown in FIG. 17, the apparatus 1700 may include a memory 1701, one or more (only one shown in the figure) processors 1702, an interface circuit 1703, and a bus 1704. Communication connections among the memory 1701, the processor 1702, and the interface circuit 1703 are implemented through the bus 1704.

The memory 1701 is configured to store instructions, and the processor 1702 is configured to invoke the instructions stored in the memory 1701.

The processor 1702 is specifically configured to obtain a computer program, to execute the corresponding construction method for the bipartite graph in the embodiment 300.

According to the construction apparatus for the bipartite graph in embodiments of this application, a communication node in a computational graph may be extracted to a top layer of the bipartite graph, to clearly display a model structure, and quickly and intuitively locate the communication node and specify a function of the communication node the communication node, thereby providing a basis for subsequent parallel policy design.

It should be understood that the apparatus 1700 may be specifically a computer, and may be configured to perform the steps and/or the procedures in the method embodiment 300.

The memory 1701 may be a read-only memory (read-only memory, ROM), a static storage device, a dynamic storage device, or a random-access memory (random-access memory, RAM). The memory 1701 may store a program. When the program stored in the memory 1701 is executed by the processor 1702, the processor 1702 and the interface circuit 1703 are configured to perform the steps of the construction method for the bipartite graph in embodiments of this application.

The processor 1702 may be a general-purpose central processing unit (central processing unit, CPU), a microprocessor, an application-specific integrated circuit (application-specific integrated circuit, ASIC), a graphics processing unit (graphics processing unit, GPU), or one or more integrated circuits, and is configured to execute a related program, to implement functions that need to be performed by units in the construction apparatus for the bipartite graph in embodiments of this application, or perform the construction method for the bipartite graph in method embodiments of this application.

The processor 1702 may alternatively be an integrated circuit chip and has a signal processing capability. In an implementation process, the steps of the construction method for the bipartite graph in this application may be completed by using instructions in a form of software in the processor 1702. The processor 1702 may be a general-purpose processor, a digital signal processor (digital signal processor, DSP), an application-specific integrated circuit (ASIC), a field programmable gate array (field programmable gate array, FPGA) or another programmable logic device, a discrete gate or transistor logic device, or a discrete hardware component. The methods, steps, and logical block diagrams that are disclosed in embodiments of this application may be implemented or performed. The general-purpose processor may be a microprocessor, or the processor may be any conventional processor or the like. The steps of the methods disclosed with reference to embodiments of this application may be directly executed and completed by a hardware decoding processor, or may be executed and completed by using a combination of hardware and software modules in the decoding processor. The software module may be located in a mature storage medium in the art, for example, a random-access memory, a flash memory, a read-only memory, a programmable read-only memory, an electrically erasable programmable memory, or a register. The storage medium is located in the memory 1701. The processor 1702 reads information in the memory 1701, and completes, in combination with hardware of the processor 1702, functions that need to be performed by the units included in the construction apparatus for the bipartite graph in embodiments of this application, or performs the construction method for the bipartite graph in the method embodiments of this application.

The interface circuit 1703 uses a transceiver apparatus, for example, but not limited to, a transceiver, to implement communication between the apparatus 1700 and another device or a communication network. For example, a program may be obtained by using the interface circuit 1703.

The bus 1704 may include a path for information transfer between various components (for example, the memory 1701, the processor 1702, and the interface circuit 1703) of the apparatus 1700.

It may be clearly understood by a person skilled in the art that, for the purpose of convenient and brief description, for a specific working process of the system, apparatus, and unit described above, refer to a corresponding process in the embodiment 300 of the construction method for the bipartite graph. Details are not described herein again.

FIG. 18 is a schematic diagram of a hardware structure of a display apparatus for a bipartite graph according to an embodiment of this application. As shown in FIG. 18, the apparatus 1800 may include a memory 1801, one or more (only one shown in the figure) processors 1802, an interface circuit 1803, and a bus 1804. Communication connections among the memory 1801, the processor 1802, and the interface circuit 1803 are implemented through the bus 1804.

The memory 1801 is configured to store instructions, and the processor 1802 is configured to invoke the instructions stored in the memory 1801.

The processor 1802 is specifically configured to obtain a computer program, to execute the corresponding display method for the bipartite graph in the embodiment 1400.

The display apparatus for the bipartite graph in embodiments of this application may process a computational graph and output a corresponding bipartite graph according to the display method for the bipartite graph in the method embodiment 1400. The output bipartite graph can clearly display a model structure of a corresponding deep learning model, to quickly and intuitively locate the communication node and specify a function of the communication node a communication node, thereby providing a basis for subsequent parallel policy design.

It should be understood that the apparatus 1800 may be specifically a computer, and may be configured to perform the steps and/or the procedures in the method embodiment 1400.

The memory 1801 may be a read-only memory (read-only memory, ROM), a static storage device, a dynamic storage device, or a random-access memory (random-access memory, RAM). The memory 1801 may store a program. When the program stored in the memory 1801 is executed by the processor 1802, the processor 1802 and the interface circuit 1803 are configured to perform the steps of the display method for the bipartite graph in embodiments of this application.

The processor 1802 may be a general-purpose central processing unit (central processing unit, CPU), a microprocessor, an application-specific integrated circuit (application-specific integrated circuit, ASIC), a graphics processing unit (graphics processing unit, GPU), or one or more integrated circuits, and is configured to execute a related program, to implement functions that need to be performed by units in the display apparatus for the bipartite graph in embodiments of this application, or perform the display method for the bipartite graph in method embodiments of this application.

The processor 1802 may alternatively be an integrated circuit chip and has a signal processing capability. In an implementation process, the steps of the display method for the bipartite graph in this application may be completed by using instructions in a form of software in the processor 1802. The processor 1802 may be a general-purpose processor, a digital signal processor (digital signal processor, DSP), an application-specific integrated circuit (ASIC), a field programmable gate array (field programmable gate array, FPGA) or another programmable logic device, a discrete gate or transistor logic device, or a discrete hardware component. The methods, steps, and logical block diagrams that are disclosed in embodiments of this application may be implemented or performed. The general-purpose processor may be a microprocessor, or the processor may be any conventional processor or the like. The steps of the methods disclosed with reference to embodiments of this application may be directly executed and completed by a hardware decoding processor, or may be executed and completed by using a combination of hardware and software modules in the decoding processor. The software module may be located in a mature storage medium in the art, for example, a random-access memory, a flash memory, a read-only memory, a programmable read-only memory, an electrically erasable programmable memory, or a register. The storage medium is located in the memory 1801. The processor 1802 reads information in the memory 1801, and completes, in combination with hardware of the processor 1802, functions that need to be performed by the units included in the display apparatus for the bipartite graph in embodiments of this application, or performs the display method for the bipartite graph in the method embodiments of this application.

The interface circuit 1803 uses a transceiver apparatus, for example, but not limited to, a transceiver, to implement communication between the apparatus 1800 and another device or a communication network. For example, a program may be obtained by using the interface circuit 1803.

The bus 1804 may include a path for information transfer between various components (for example, the memory 1801, the processor 1802, and the interface circuit 1803) of the apparatus 1800.

It may be clearly understood by a person skilled in the art that, for the purpose of convenient and brief description, for a specific working process of the system, apparatus, and unit described above, refer to a corresponding process in the embodiment 1400 of the display method for the bipartite graph. Details are not described herein again.

An embodiment of this application provides a computer-readable storage medium. The computer-readable storage medium stores a computer program. When the computer program is executed, some or all of the steps recorded in any one of the embodiments of the construction method for the bipartite graph and/or the embodiments of the display method for the bipartite graph are implemented.

An embodiment of this application provides a computer program. The computer program includes instructions. When the computer program is executed by a processor, some or all of the steps recorded in any one of the embodiments of the construction method for the bipartite graph and/or the embodiments of the display method for the bipartite graph are implemented.

In the foregoing embodiments, the description of each embodiment has respective focuses. For a part that is not described in detail in an embodiment, refer to related descriptions in other embodiments. It should be noted that, for brief description, the foregoing method embodiments are represented as a series of actions. However, a person skilled in the art should appreciate that this application is not limited to the described order of the actions, because some steps may be performed in another order or simultaneously according to this application. In addition, a person skilled in the art should also appreciate that the related actions and modules are not necessarily mandatory to this application.

In the several embodiments provided in this application, it should be understood that the disclosed apparatus may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The foregoing units described as separate parts may or may not be physically separate, and parts displayed as units may or may not be physical units, that is, may be located in one position, or may be distributed on a plurality of network units. Some or all of the units may be selected according to actual requirements to achieve the objectives of the solutions of embodiments.

The foregoing embodiments are merely intended for describing the technical solutions of this application rather than limiting this application. Although this application is described in detail with reference to the foregoing embodiments, person of ordinary skill in the art should understand that they may still make modifications to the technical solutions described in the foregoing embodiments or make equivalent replacements to some technical features thereof, without departing from the spirit and scope of the technical solutions of embodiments of this application.

What is claimed is:

1. A construction method for a bipartite graph, wherein the method comprises:
searching a computational graph for at least one cross-communication edge corresponding to a first communication node, wherein the first communication node is one of M communication nodes comprised in the computational graph, the first communication node corresponds to P predecessor nodes and Q successor nodes, each of the at least one cross-communication edge indicates a communication path between one of the P predecessor nodes and one of the Q successor nodes, and no cross-communication edge passes through the M communication nodes, wherein M, P, and Q are positive integers; and
cutting cross-communication edges respectively corresponding to the M communication nodes, and performing an aggregation operation to obtain the bipartite graph, wherein any two of the M communication nodes are directly connected without an edge in the bipartite graph.

2. The method according to claim 1, wherein
each cross-communication edge comprises at least one subedge, and each of the at least one subedge is directly connected to two computation nodes; and
each of the at least one subedge corresponds to one weight coefficient, and the weight coefficient corresponding to each subedge is determined by types of the two computation nodes directly connected to each subedge.

3. The method according to claim 2, wherein the M communication nodes correspond to a total of N cross-communication edges, wherein N is a positive integer; and the cutting cross-communication edges respectively corresponding to the M communication nodes comprises:
cutting one subedge in each of the N cross-communication edges, wherein
when E cross-communication edges in the N cross-communication edges comprise a common subedge, a sum of weight coefficients respectively corresponding to all subedges cut in the E cross-communication edges is the largest or the smallest, wherein E is a positive integer less than or equal to N; or when an i^{th} cross-communication edge and another cross-communication edge in the N cross-communication edges do not comprise a common subedge, a subedge with a smallest weight coefficient or a largest weight coefficient among subedges comprised in the i^{th} cross-communication edge is cut, wherein i is a positive integer.

4. The method according to claim 1, wherein the computational graph after cutting comprises K connected blocks, wherein K is a positive integer; and the performing an aggregation operation to obtain the bipartite graph comprises:
separately aggregating the K connected blocks in the computational graph after the cutting to obtain the bipartite graph, wherein
the K connected blocks are obtained by grouping computation nodes in the computational graph based on positions of the M communication nodes in the computational graph, the bipartite graph comprises K level-1 aggregation nodes and the M communication nodes, any two of the K level-1 aggregation nodes are directly connected without an edge, and the K level-1 aggregation nodes respectively belong to K name scopes.

5. The method according to claim 4, wherein
each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, wherein j is a positive integer; and
the nodes at the j^{th} layer comprise the aggregation node and/or the computation node, and the computation node is a node that cannot be expanded.

6. The method according to claim 5, wherein the method further comprises:
updating a first name scope when a subedge between a first computation node and a second computation node in the first name scope is cut, wherein the first name scope is a name scope in the computational graph; and
constructing a name scope that comprises the first computation node, wherein the first computation node does not belong to an updated first name scope.

7. The method according to claim 5, wherein the method further comprises:
computing a hash value of the aggregation node and a hash value of the computation node in the bipartite graph, wherein
when the node is the aggregation node, a hash value of the node is equal to a sum of hash values of all nodes obtained by expanding the aggregation node; or when the node is the computation node, a hash value of the node is determined by an attribute of the computation node, wherein the attribute of the computation node comprises a type, an in-degree, an out-degree, a type of an auxiliary node, and a quantity of auxiliary nodes of the computation node.

8. The method according to claim 7, wherein the method further comprises:
displaying a plurality of nodes in the bipartite graph in a stacked manner, wherein
the plurality of nodes are obtained by expanding the same aggregation node once, hash values of the plurality of nodes are the same, and the plurality of nodes are connected in serial or parallel.

9. A display method for a bipartite graph, wherein the method comprises:
inputting a computational graph, and outputting the bipartite graph based on the computational graph, wherein
the computational graph comprises M communication nodes, a first communication node in the M communication nodes corresponds to P predecessor nodes and Q successor nodes, the first communication node corresponds to at least one cross-communication edge, each of the at least one cross-communication edge indicates a communication path between one of the P predecessor nodes and one of the Q successor nodes, and no cross-communication edge passes through the M communication nodes, wherein P, Q, and M are positive integers; and cross-communication edges respectively corresponding to the M communication nodes are not connected in the bipartite graph, and any two of the M communication nodes are directly connected without an edge in the bipartite graph.

10. The method according to claim 9, wherein
the computational graph comprises C computation nodes, and the bipartite graph comprises K level-1 aggregation nodes, wherein
the K level-1 aggregation nodes are obtained by aggregating the C computation nodes, each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, wherein C, K, and j are positive integers;
and the nodes at the j^{th} layer comprise the aggregation node and/or the computation node, and the computation node is a node that cannot be expanded.

11. The method according to claim 10, wherein
the bipartite graph comprises a stack structure, wherein
the stack structure comprises a connection relationship identifier and a quantity identifier, the connection relationship identifier represents a connection relationship between a plurality of nodes, the quantity identifier represents a quantity of the plurality of nodes, the plurality of nodes are obtained by expanding the same aggregation node once, hash values of the plurality of nodes are the same, and the connection relationship between the plurality of nodes is a serial connection or a parallel connection.

12. The method according to claim 11, wherein
when the node is the aggregation node, a hash value of the node is equal to a sum of hash values of all nodes obtained by expanding the aggregation node; or when the node is the computation node, a hash value of the node is determined by an attribute of the computation node, wherein the attribute of the computation node comprises a type, an in-degree, an out-degree, a type of an auxiliary node, and a quantity of auxiliary nodes of the computation node.

13. An apparatus for constructing a bipartite graph, wherein the apparatus comprises:
a processor, and
a memory coupled to the processor and configured to store a plurality of instructions that, when executed by the processor, causes the processor to:
search a computational graph for at least one cross-communication edge corresponding to a first communication node, wherein the first communication node is one of M communication nodes comprised in the computational graph, the first communication node corresponds to P predecessor nodes and Q successor nodes, each of the at least one cross-communication edge indicates a communication path between one of the P predecessor nodes and one of the Q successor nodes, and no cross-communication edge passes through the M communication nodes, wherein M, P, and Q are positive integers; and
cut cross-communication edges respectively corresponding to the M communication nodes, and performing an aggregation operation to obtain the bipartite graph, wherein any two of the M communication nodes are directly connected without an edge in the bipartite graph.

14. The apparatus according to claim 3, wherein
each cross-communication edge comprises at least one subedge, and each of the at least one subedge is directly connected to two computation nodes; and
each of the at least one subedge corresponds to one weight coefficient, and the weight coefficient corresponding to each subedge is determined by types of the two computation nodes directly connected to each subedge.

15. The apparatus according to claim 14, wherein the M communication nodes correspond to a total of N cross-communication edges, wherein N is a positive integer; and the cutting cross-communication edges respectively corresponding to the M communication nodes, further causes the processor to:
cut one subedge in each of the N cross-communication edges, wherein
when E cross-communication edges in the N cross-communication edges comprise a common subedge, a sum of weight coefficients respectively corresponding to all subedges cut in the E cross-communication edges is the largest or the smallest, wherein E is a positive integer less than or equal to N; or when an i^{th} cross-communication edge and another cross-communication edge in the N cross-communication edges do not comprise a common subedge, a subedge with a smallest weight coefficient or a largest weight coefficient among subedges comprised in the i^{th} cross-communication edge is cut, wherein i is a positive integer.

16. The apparatus according to claim 13, wherein the computational graph after cutting comprises K connected blocks, wherein K is a positive integer; and the performing an aggregation operation to obtain the bipartite graph, further causes the processor to:
separately aggregate the K connected blocks in the computational graph after the cutting to obtain the bipartite graph, wherein
the K connected blocks are obtained by grouping computation nodes in the computational graph based on positions of the M communication nodes in the computational graph, the bipartite graph comprises K level-1 aggregation nodes and the M communication nodes, any two of the K level-1 aggregation nodes are directly connected without an edge, and the K level-1 aggregation nodes respectively belong to K name scopes.

17. The apparatus according to claim 16, wherein
each of the K level-1 aggregation nodes is of a hierarchical structure, nodes at a j^{th} layer in the hierarchical structure are obtained by expanding an aggregation node at a (j−1)^{th} layer in the hierarchical structure, a first layer in the hierarchical structure is the level-1 aggregation node, and the nodes at the j^{th} layer belong to different name scopes, wherein j is a positive integer; and
the nodes at the j^{th} layer comprise the aggregation node and/or the computation node, and the computation node is a node that cannot be expanded.

18. The apparatus according to claim 17, wherein further causes the processor to:
update a first name scope when a subedge between a first computation node and a second computation node in the first name scope is cut, wherein the first name scope is a name scope in the computational graph; and
construct a name scope that comprises the first computation node, wherein the first computation node does not belong to an updated first name scope.

19. The apparatus according to claim 17, wherein further causes the processor to:
computing a hash value of the aggregation node and a hash value of the computation node in the bipartite graph, wherein
when the node is the aggregation node, a hash value of the node is equal to a sum of hash values of all nodes obtained by expanding the aggregation node; or when the node is the computation node, a hash value of the node is determined by an attribute of the computation node, wherein the attribute of the computation node comprises a type, an in-degree, an out-degree, a type of an auxiliary node, and a quantity of auxiliary nodes of the computation node.

20. The apparatus according to claim 17, wherein further causes the processor to:
display a plurality of nodes in the bipartite graph in a stacked manner, wherein
the plurality of nodes are obtained by expanding the same aggregation node once, hash values of the plurality of nodes are the same, and the plurality of nodes are connected in serial or parallel.
